(19) United States
(12) Patent Application Publication
(10) Pub. No.: US 2005/0069735 A1
(43) Pub. Date: Mar. 31, 2005

(54) Polymer electrolyte membrane fuel cell system

(76) Inventors: Paul E. George II, Powell, OH (US); James H. Saunders, Worthington, OH (US); Bhima R. Vijayendran, Dublin, OH (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/913,293

(22) Filed: Aug. 6, 2004

Related U.S. Application Data
(63) Continuation-in-part of application No. PCT/US03/03864, filed on Feb. 6, 2003.
(60) Provisional application No. 60/354,770, filed on Feb. 6, 2002.

(51) Int. Cl. H01M 8/00; H01M 8/10

(52) U.S. Cl. 429/13; 429/32; 429/33

(57) ABSTRACT

The invention also relates to a fuel cell system comprising: a fuel processor for producing hydrogen from a fuel; and a fuel cell stack including a plurality of polymer electrolyte membranes and a plurality of electrodes; where the polymer electrolyte membrane comprises a proton conducting hydrocarbon-based polymer membrane, the polymer having a backbone and having acidic groups on side chains attached to the backbone. The invention also relates to methods of removing contaminants from the fuel cell electrode.

### CROSS-REFERENCE TO RELATED APPLICATIONS

This application is a continuation-in-part of co-pending International Application No. PCT/US03/03864 filed Feb. 6, 2003 claiming priority to U.S. Patent Application No. 60/354,770 filed Feb. 6, 2002. International Patent Application PCT/US03/03864 was published as WO 03/067695 on Aug. 14, 2003 in English under PCT Article 21(2).

### TECHNICAL FIELD

This invention relates in general to fuel cell systems, and in particular to a fuel cell system having a method of removing contaminants from the fuel cell electrode, and also to a fuel cell system including a fuel cell having an improved polymer electrolyte membrane. Preferably, the fuel cell system includes both the contaminant removal method and the improved membrane.

### BACKGROUND OF THE INVENTION

Fuel cells are a promising technology for generating electricity and heat with higher efficiency and lower emissions than current methods. Polymer electrolyte membrane (“PEM”) fuel cells include a polymer membrane sandwiched between an anode and a cathode. A fuel such as hydrogen or methanol is flowed into contact with the anode. The fuel give up electrons at the anode, leaving positively charged protons. On the opposite side of the cell, the cathode adsorbs oxygen from the air, generating a potential that pulls the electrons through an external circuit to give them to the adsorbed oxygen. When an adsorbed oxygen receives two electrons it forms a negatively charged oxygen anion. The polymer electrolyte membrane allows the protons to diffuse through the membrane while blocking the flow of the other materials. When two protons encounter an oxygen anion they join together to form water.

While there has been substantial progress in fuel cells, the barriers that remain for commercialization are significant. In particular, the cost of fuel cells remains high. Presently, the only commercially available polymer electrolyte membranes are fluorinated polymer membranes sold under the tradename Nafion™ by Dupont, which are sold at a relatively high cost. The fluorinated polymer membranes also have other drawbacks, such as poor durability at high temperatures, susceptibility to contamination by carbon monoxide at normal operating temperatures of 80° C., methanol crossover in a direct methanol fuel cell, and poor water management characteristics (high electroosmotic drag due to inherent hydration requirements).

U.S. Pat. No. 5,525,436 by Savinell et al. discloses an alternative polymer electrolyte membrane comprising a basic polymer complexed with a strong acid, or comprising an acidic polymer such as a polymer containing sulfonate groups. There is still a need for other polymer electrolyte membrane materials that can be used as improved alternatives to the conventional fluorinated polymer membranes.

Fuel cells for stationary applications are fueled primarily by methane and propane, from which hydrogen is obtained in a fuel processing unit that combines steam reforming with water-gas shifting and carbon monoxide cleanup. It is widely recognized that even 50 ppm of carbon monoxide (CO) in the fuel can coat the anode of the fuel cell, reducing the area available for hydrogen to react, and limiting the fuel cell current. CO is also a major poison with reformed methanol and direct methanol fuel cells.

Reforming methane produces about 10% or higher CO. This is typically reduced to about 1 percent CO in a water-gas shift reactor, followed by a reduction to 10 to 50 ppm in a CO clean-up reactor usually including a preferential oxidation step. Both the water-gas shift reactor and the clean-up reactor are major costs in the fuel cell system. For instance, in one approach, the PROX clean-up reactor uses two to three reaction stages operating at temperature of 160° C. to 190° C. compared to the stack temperature of 80° C. The water-gas shift reactor typically consists of two reactor stages operating at higher and lower temperatures. In addition, a stack running on 10 to 50 ppm of CO must be about twice the electrode area of a stack operating on pure H₂.

Cleaning an anode of an electrochemical energy converter by changing the potential of the anode was proposed by Bockris in “Basis of Possible Continuous Self Activation In an Electrochemical Energy Converter”, J. Electroanal. Chem., vol. 7, pp. 487-490 (1964). In his scheme, a cleaning current pulse of about 40 mA was used. During the time the pulse was on, cleaning was accomplished but little or no power was produced. When the pulse was off, power was produced using the cleaned electrode, which gradually became re-covered with CO. Consequently, this system is most attractive when the cleaning pulses are of short duration in the duty is cycle. The cleaning pulses may consume energy, so the power produced must be larger than the power consumed by the cleaning pulses for a net gain in power to be realized.

Publications using and extending this approach have appeared, including International Publication No. WO 98/42038 by Stimming et al. applying this technology to PEM fuel cells, and Carrette, Friedrich, Huber and Stimming, “Improvement of CO Tolerance of Proton Exchange Membrane Fuel Cells by a Pulsing Technique”, PCCP, v.3, n.3, Feb. 7, 2001, pp 320-324. The Stimming approach also used a cleaning current pulse of between 100 and 640 mA/cm² with varying pulse durations and frequencies. Square wave current pulses, similar to the work of Bockris, are used. In addition, Stimming has proposed using positive voltage pulses for cleaning. Stimming showed that this method could clean electrodes with 1 percent CO in the feed stream for laboratory, bench-top experiments.

Wang and Fedkiw,“Pulsed-Potential Oxidation of Methanol, I”, J. Electrochem. Soc., v. 139 n. 9, September 1992, 2519-2525, and “Pulsed-Potential Oxidation of Methanol, II”, v. 139, n. 11, 3151-3158, showed that pulsing a direct methanol fuel cell with positive square wave pulses of a certain frequency could result in a substantial increase in output current. The increase was attributed to cleaning intermediates from the electrode.

The pulsing approaches used in the current patent and technical literature do not address pulsing waveform shapes other than square waves. In addition, methods of determining suitable waveform shapes for different electrodes, electrolytes, load characteristics, and operating conditions are not discussed. More powerful techniques are needed for electrode cleaning in fuel cells, particularly techniques that would allow the fuel cell to consistently and robustly operate on 1 percent and higher levels of CO, while eliminating the CO clean-up reactor, simplifying the reformer and shift reactors, and reducing the stack size. The invention reported herein utilizes the inherent dynamical properties of the electrode to improve the fuel cell performance and arrive at a suitable pulsing waveform shape or electrode voltage control method.

Furthermore, the literature to date that is known to us is restricted to CO levels less than 1 per cent. The invention reported herein allows operation at higher levels of CO, which enables the reformer to be substantially simplified.

### SUMMARY OF THE INVENTION

This invention relates to a fuel cell system comprising:
a fuel processor for producing hydrogen from a fuel;
a fuel cell stack including a plurality of polymer electrolyte membranes and a plurality of electrodes; and
a method of optimizing a waveform of an electrical current applied to an electrode, comprising the steps of:
applying an electrical current to an electrode of the fuel cell stack;
determining a waveform of the voltage or the current of the electrical current;
representing the waveform by a mathematical description such as a number of points or an analytical function characterized by a number of unknown coefficients and a fixed number of known functions;
measuring a function of the fuel cell associated with the application of the electrical current;
feeding the waveform description and the measurements to an algorithm, which may be in a computer program or other calculating device including manual calculations, including an optimization routine which uses the points or coefficients as independent variables for optimizing the function of the device; and
performing the calculations to determine values of the points or coefficients which optimize the function of the device, and thereby determine an optimized waveform of the electrical current to be applied to the electrode of the fuel cell.

The invention also relates to a fuel cell system comprising:
a fuel processor for producing hydrogen from a fuel;
a fuel cell stack including a plurality of polymer electrolyte membranes and a plurality of electrodes; and
a feedback control method of operating a fuel cell comprising applying voltage control to an anode of the fuel cell using the following algorithm:
a) determining a mathematical model that relates the instantaneous coverage of hydrogen and carbon monoxide to the overvoltage applied to the anode;
b) forming an observer that relates the instantaneous coverage of the hydrogen and carbon monoxide to the measured current of the fuel cell;
c) driving the estimated carbon monoxide coverage to a low value by varying the overvoltage;
d) driving the estimated hydrogen coverage to a high value by varying the overvoltage; and
e) repeating steps a) through d) as necessary.

The invention also relates to a fuel cell system comprising:
a fuel processor for producing hydrogen from a fuel; and
a fuel cell stack including a plurality of polymer electrolyte membranes and a plurality of electrodes;
where the polymer electrolyte membrane comprises a proton conducting hydrocarbon-based polymer membrane, the polymer having a backbone and having acidic groups on side chains attached to the backbone.

Other embodiments of the methods and membranes of the invention are described herein.

Various advantages of this invention will become apparent to those skilled in the art from the following detailed description of the preferred embodiments, when read in light of the accompanying drawings.

### BRIEF DESCRIPTION OF THE DRAWINGS

FIG. 1A shows voltage waveforms for a methanol fuel cell, showing that negative pulsing delivers the most current.

FIG. 1B shows current waveforms for a methanol fuel cell, showing that negative pulsing delivers the most current.

FIG. 2 shows the charge delivered by the methanol fuel cell during the experiments.

FIGS. 3A and 3B show a voltage waveform and the resulting current for the methanol fuel cell.

FIGS. 3C and 3D show another voltage waveform and the resulting current for the methanol fuel cell.

FIGS. 3E and 3F show another voltage waveform and the resulting current for the methanol fuel cell.

FIG. 4 shows the charge delivered by the various waveform shapes in FIGS. 3A, 3C and 3E.

FIG. 5 is a representation of a voltage waveform by a fixed number of points.

FIG. 6 shows a comparison of the charge delivered by a dynamic electrode with hydrogen fuel and different levels of carbon monoxide, compared to normal fuel cell operation.

FIG. 7A shows voltage waveforms of a fuel cell using hydrogen containing 1% CO as the fuel.

FIG. 7B shows the current resulting from the voltage waveforms of FIG. 7A.

FIG. 8 is a schematic of a device including a fuel cell, electronic pulsing hardware and voltage boosting circuitry.

FIG. 9 shows anode current and voltage waveforms before the voltage boosting circuitry of the device of FIG. 8.

FIG. 10A shows a plot of overpotential in a fuel cell using feedback linearization.

FIG. 10B shows a plot of the coverage of CO in a fuel cell using feedback linearization.

FIG. 11A shows voltage waveforms of a fuel cell using a feedback control technique based on natural oscillations in voltage to clean the electrode.

FIG. 11B shows a current waveform of the fuel cell of FIG. 11A.

FIG. 12 is a representation of a two-phase morphological structure in a sulfonated side chain polymer of the present invention.

FIG. 13 is a representation of a random distribution of sulfonate groups in a sulfonated hydrocarbon-based polymer of the prior art.

FIGS. 14-23 are ionic conductivity plots of polymer electrolyte membranes made from hydrocarbon-based polymers, in comparison with a conductivity plot of a Nafion™ membrane.

FIG. 24 shows ionic conductivity plots of two polymer electrolyte membranes according to the invention, in comparison with a conductivity plot of a Nafion™ membrane.

### DETAILED DESCRIPTION OF PREFERRED EMBODIMENTS OF THE INVENTION

Fuel Cell Systems Including Methods of Removing Electrochemically Active Contaminants from Fuel Cell Electrodes

The present invention relates in general to methods of removing carbon monoxide or other contaminants from the anode or cathode of a fuel cell, thereby maximizing or otherwise optimizing a performance measure such as the power output or current of the fuel cell. The electrochemically active contaminant is any contaminant that can be removed by setting the operating voltage at a voltage bounded by −Voc and +Voc, where Voc is the open circuit voltage of the apparatus used in the process.

The methods usually involve varying the overvoltage of an electrode, which is the excess electrode voltage required over the ideal electrode voltage. This can be done by varying the load on the device, i.e., by placing a second load that varies in time in parallel with the primary load, or by using a feedback system that connects to the anode, the cathode and a reference electrode. A feedback system that is commonly used is the potentiostat. In some cases the reference electrode can be the cathode; in other cases it is a third electrode.

Broadly, the different methods involve the following concepts:
1. Obtaining useful power during the cleaning pulse of a pulsed cleaning operation used to remove contaminants from a fuel cell electrode. This enables (1) operation of a fuel cell at high CO levels, (2) a simplified fuel cell system with a reformer that produces CO at up to 10% instead of the usual 50 ppm or so, and (3) a fuel cell operating at nearly constant voltage with high current output, using a voltage booster that operates during the cleaning pulse.
2. Control of the voltage waveform during a cleaning operation to minimize the magnitude or duration of the cleaning voltage, maximize performance, and/or to satisfy some other system constraint, such as following the load or avoiding voltage and current conditions that adversely affect reliability of the electrode.
3. A feedback control technique based on a natural oscillation in fuel cell voltage to maintain a desired current, load profile, or to maximize performance by cleaning contaminants.
   Improved Waveform for Pulsing a Fuel Cell Anode or Cathode to Maximize the Current or Power Produced

In a preferred embodiment, the present invention provides an improved waveform for pulsing a direct methanol fuel cell, where the anode potential is made negative with respect to the cathode, followed by the usual power production potential which was about 0.6 volts relative to SCE in our half cell experiments:

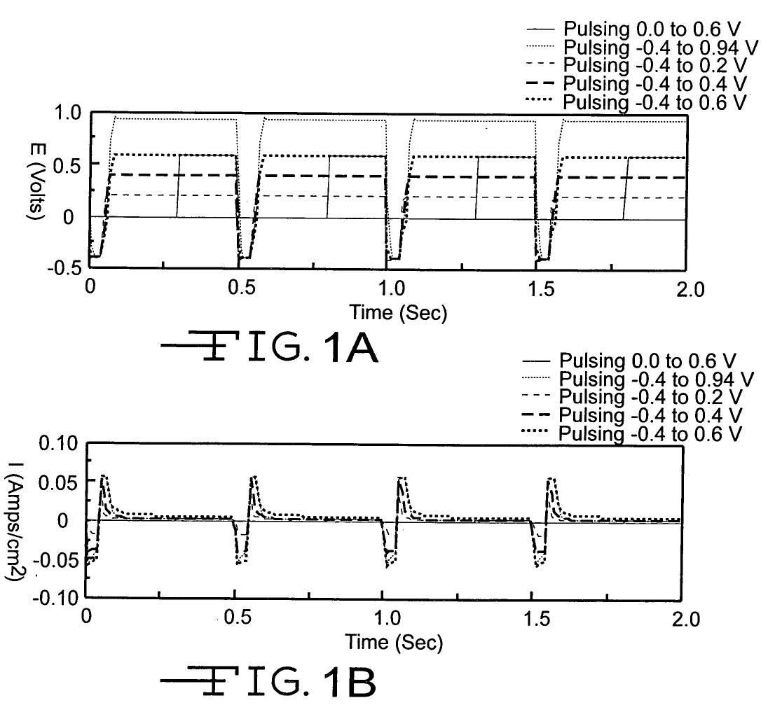

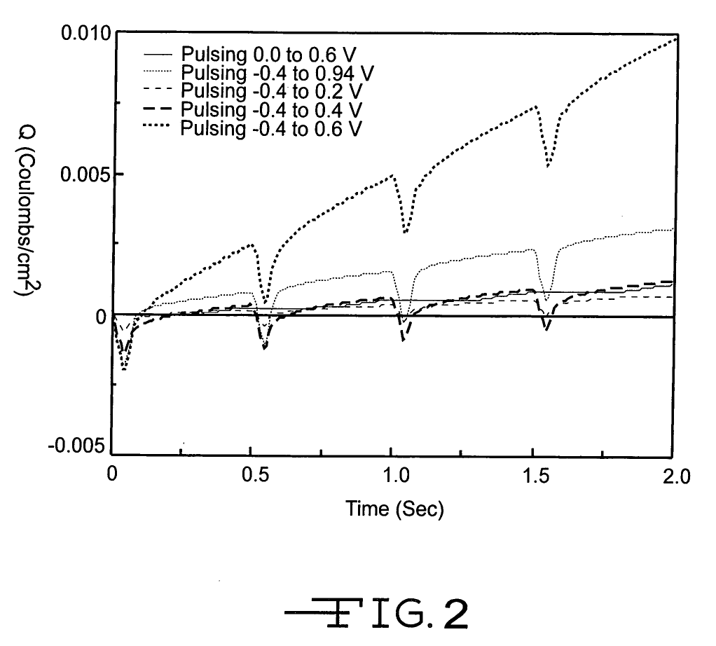

Experiments were performed with a standard three electrode cell containing 1.0 M methanol and 0.5 M sulfuric acid. The anode was platinum and the cathode was a saturated calumel electrode (“SCE”). This was a batch system with the fuel (methanol) mixed with the electrolyte (sulfuric acid) in the cell. The anode voltage was controlled by a potentiostat with a voltage waveform that could be generated either by the potentiostat directly or by externally triggering the potentiostat with a programmable function generator. The resulting data, shown in FIGS. 1A and 1B for five different experiments, show that the current output is larger and substantial when the waveform is made negative (relative to the cathode) during a short cleaning pulse. FIG. 2 illustrates this better, showing that the charge delivered is larger when the cleaning pulse is negative and the voltage level during power production is at 0.6 volts (the top curve—dashed), which is near the peak methanol oxidation potential from a cyclic voltammogram. For comparison the solid black curve has a cleaning potential at 0.0 volts and power production at 0.6 volts. Notice that the current traces have a positive and a negative component to them. When the current is positive, the cell is delivering current. When the current is negative, the cell is receiving current. Consequently, it is desirable to maximize the positive current and minimize the negative current.

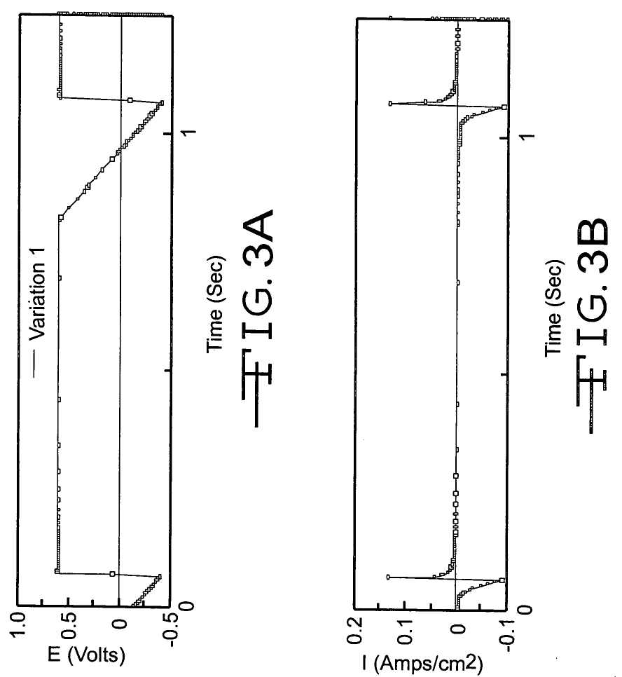

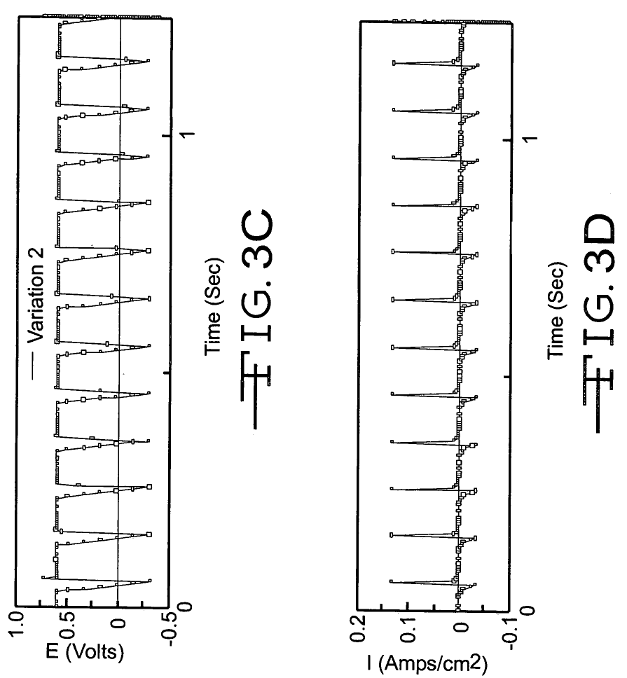

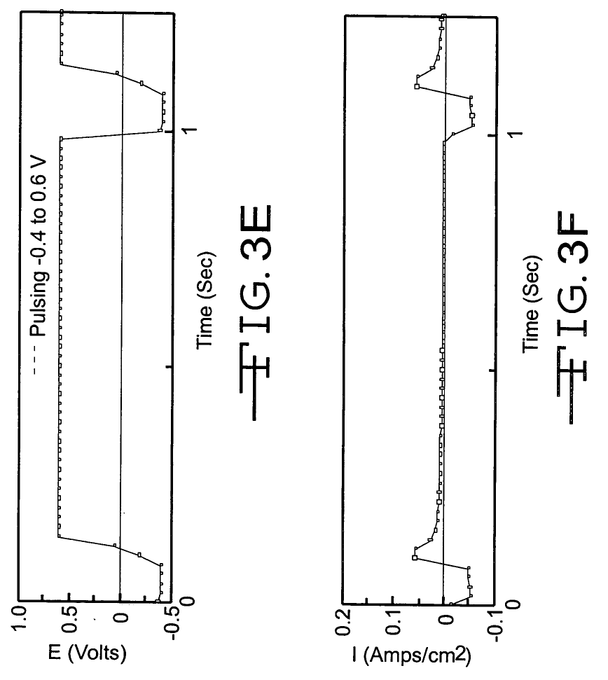

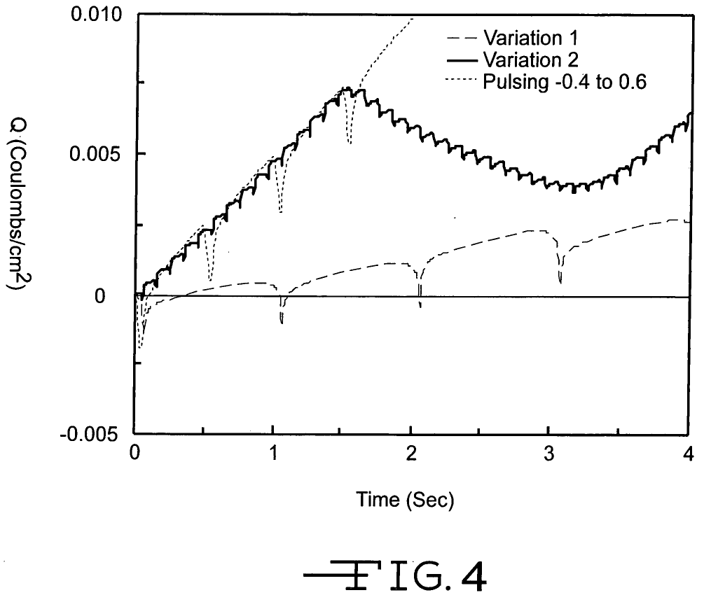

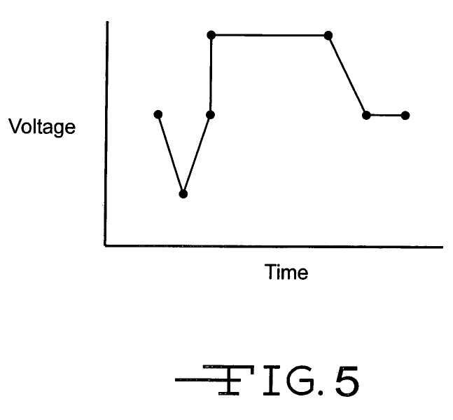

To influence the positive and negative currents, we varied the shape of the voltage pulses. FIGS. 3A-3F show that varying the voltage shapes can strongly influence the shape of the current traces and can reduce the negative current. FIG. 4 illustrates the charge delivered by the various waveform shapes shown in FIGS. 3A, 3C and 3E.

The results of these experiments indicate that the waveform can be optimized by a systematic, computational procedure in order to deliver substantially more power than existing fuel cells. The experiments show that varying the waveform can significantly vary the current output.

To illustrate the method, consider a waveform to be represented by a fixed number of points, as shown in FIG. 5. The number of points is arbitrary, but the more points, the longer the optimization time that is required. The waveform is a voltage or current waveform that is connected to the anode of a fuel cell, such that the anode is operated at that voltage, or perhaps is operated at that voltage plus or is minus a fixed offset voltage. The offset voltage may vary slowly with the operating conditions due to, for instance, changes in the load. The waveform variation is much faster than any variation in the offset voltage.

This waveform pattern is fed to the anode and repeated at a frequency specified by the points, as the figure illustrates. Measurements are made of the power or current or other performance parameter, whichever is most appropriate, delivered by the fuel cell. The performance parameter and waveform points are then fed to an algorithm, which may be in a computer program or hand calculation, which optimizes the waveform shape to maximize the performance, such as power or current delivered.

The optimum waveform can thus be determined for the specific fuel cell electrode and operating conditions. This optimizing procedure can be repeated as often as necessary during operation to guard against changes in the electrode or other components over time or for different operating conditions.

Mathematically, the points describing the waveform can be considered to be independent variables for the optimization routine. The net current or power produced (current or power that is output minus any current or power supplied to the electrode) is the objective function to be optimized. A person skilled in the art of optimization could select a computer algorithm to perform the optimization. Typical algorithms might include steepest descent, derivative-free algorithms, annealing algorithms, or many others well-known to those skilled in the art.

Alternatively, the waveform could be represented by a set of functions containing one or more unknown coefficients. These coefficients are then analogous to the points in the preceding description, and may be treated as independent variables in the optimization routine. As an example, the waveform could be represented by a Fourier Series, with the coefficient of each term in the series being an unknown coefficient.

Obtaining Useful Power During the Cleaning Pulse of a Pulsed Cleaning Operation Used to Remove Contaminants from a Fuel Cell

Pulsed cleaning of electrochemically active contaminants from an electrode of a fuel cell involves raising the overvoltage of the electrode to a sufficiently high value to oxidize the contaminants adsorbed onto the electrode surface. For example, the pulsed cleaning of an anode or cathode of a fuel cell usually involves raising the overvoltage to oxidize adsorbed CO to CO₂. When a sufficient amount of time has elapsed, the overvoltage is dropped back to the conventional overvoltage where power is produced.

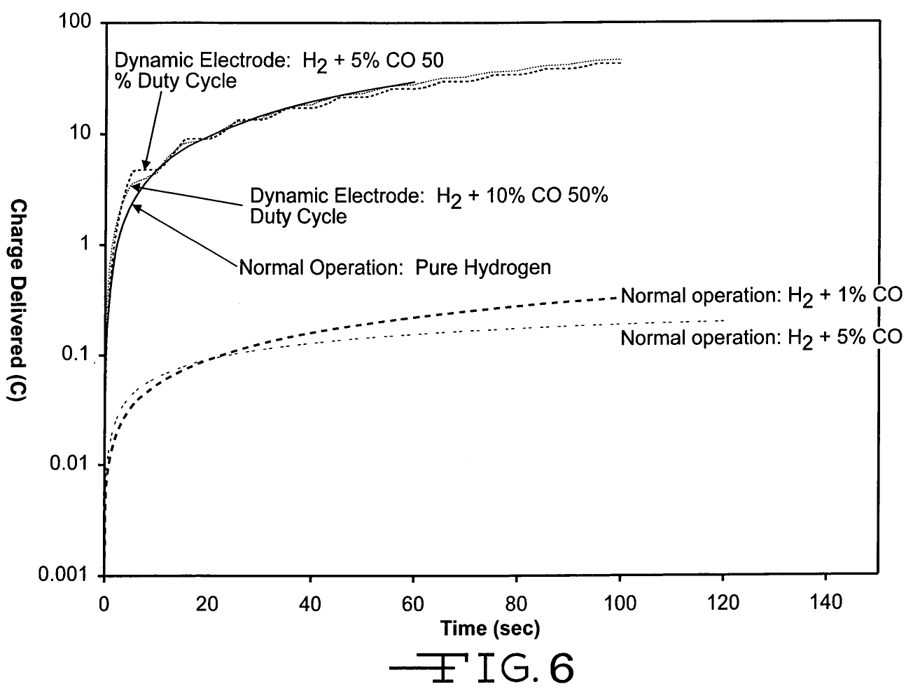

Conventional thinking is that little or no useful power is generated during the cleaning pulse. However, our work with pulsing of a fuel cell anode has surprisingly shown that high current can be obtained during the cleaning pulse. Also surprisingly, our work has shown that when the hydrogen fuel contains high levels of CO, up to 10 per cent, currents can be obtained approaching that obtained when pure hydrogen is used as the fuel. FIG. 6 shows a plot of charge delivered by a 5 cm² PEM fuel cell, operated as a single cell at room temperature under a standard three-electrode configuration with a potentiostat and air supplied to the cathode, as a function of time. The smooth curve at the top is the charge obtained when pure hydrogen is used as the fuel. Without pulsing, when 1 per cent CO is added to the hydrogen, the charge drops by more than two orders of magnitude. Similar performance is seen with 5 per cent CO. However, when the fuel cell anode is pulsed, the charge increases, and particular combinations of pulse width and frequency result in increased charge. At 5 and 10 per cent CO, the figure shows data that reveal that the cell charge is nearly the same as the cell charge when the fuel is pure hydrogen.

Thus, we have discovered that pulsing of a fuel cell anode allows the fuel cell to operate using a hydrogen fuel containing greater than 1% CO, up to 10% CO or possibly higher. Pulsing can take care of much larger amounts of CO than previously thought. In the past, most fuel cells have been operated using a hydrogen fuel containing 50 to 100 ppm, whereas we have found that up to 10% or more CO can be used (at least 10,000 times the previous level). This invention permits a step change increase in CO contamination with minimal impact on current output.

Advantageously, the ability to operate a fuel cell with hydrogen having high CO levels enables a simplified, less costly fuel cell system to be used. Operation at high CO levels enables the fuel processor to be much simpler, less costly and smaller in size. The fuel processor of a conventional fuel cell system usually includes a fuel reformer, a multi-stage water-gas shift reactor and a CO cleanup reactor. The simplified fuel processor of the invention can include a fuel reformer and a simplified water-gas shift reactor, for example a one-stage or two-stage reactor instead of a multi-stage reactor. In some cases, the water-gas shift reactor can be eliminated. The cleanup reactor can usually be eliminated in the simplified fuel processor. Essentially this invention enables the fuel cell electrode to tolerate CO concentrations of 10 per cent or higher, and therefore the fuel processor can operate with simplified components since it can produce CO concentrations of 10 per cent or higher.

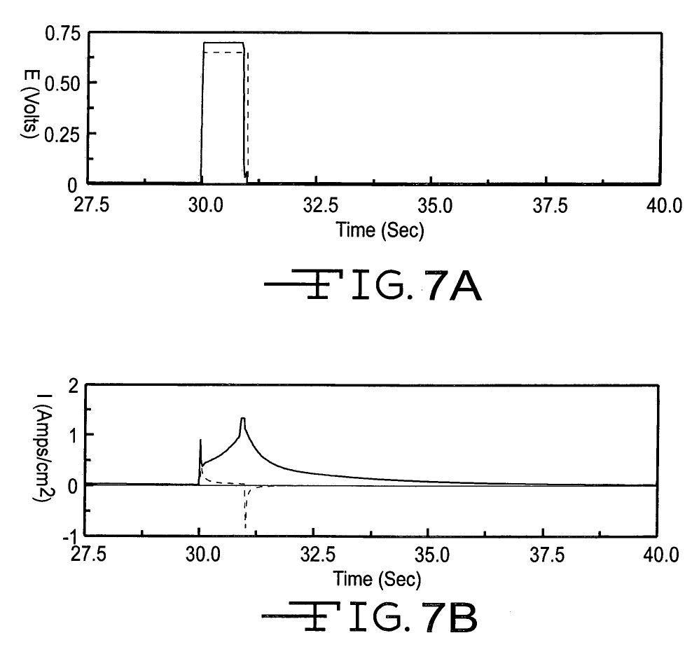

An examination of the cell voltage and current is shown in FIGS. 7A and 7B for 1% CO in hydrogen in the same fuel cell and same operating conditions as that in FIG. 6. Two cases are shown. In the first, the overvoltage waveform varies between 0.05 and 0.7 volts. In the second, the overvoltage varies between 0.05 and 0.65 volts. The figure shows that the cell current is high when the voltage reaches 0.7 volts, but is much lower when the voltage reaches 0.65 volts. This indicates that 0.7 volts is the CO oxidizing voltage, in agreement with known theory. The initial peak in current, when the voltage first reaches 0.7 volts, is expected to be the CO being oxidized. The current then decreases and then increases steadily as the hydrogen reaches the newly cleaned surface. The hydrogen current is high at this large overvoltage.

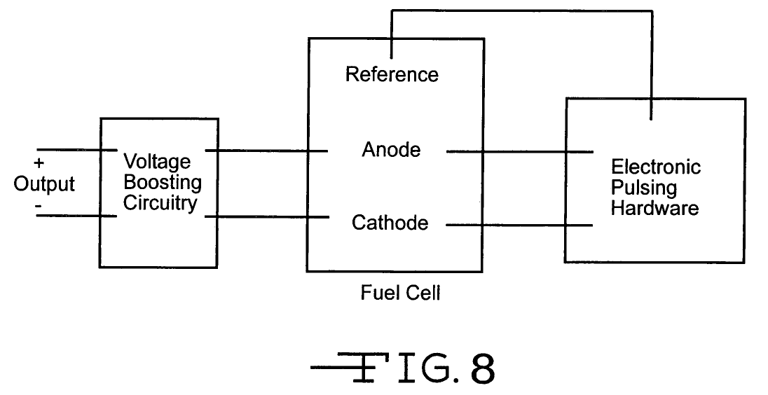

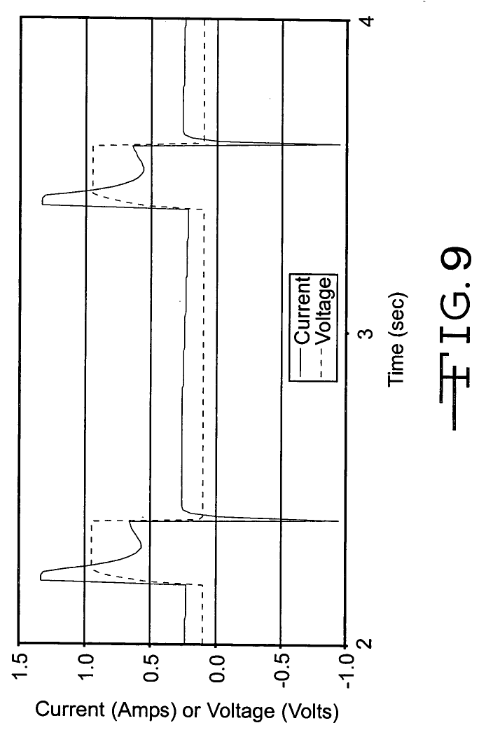

Consequently, the current is high during the CO oxidizing voltage, but the overall cell output voltage is low (since the overvoltage is high). However, the power, which is defined as the product of voltage times current, is surprisingly high for CO concentrations greater than 1 percent. This enables various voltage conditioning circuits to be used to convert the current or voltage or both to a desired form. In one embodiment of our invention, the output voltage is boosted to a more usable value by using a voltage boosting circuit, such as a switching circuit. These devices typically keep the output energy nearly the same (efficiencies are usually over 80 percent), but increase the voltage while decreasing the current. A schematic of the device, along with typical waveforms of voltage and current before the conditioning circuit is shown in FIGS. 8 and 9. Thus, one embodiment of the invention relates to a fuel cell having a pulsed electrode in combination with a voltage conditioning circuit, such as a voltage booster to change the cell voltage during the oxidation pulse to a desired level. Furthermore, all of the cleaning techniques described in this patent may be used for fuel cells with CO concentrations greater than 1 percent.

Model Based Feedback Control of the Electrode Voltage

When an electrode is pulsed, some loss of voltage due to the pulse is inevitable. This loss is reduced when the fraction of time spent pulsing is minimized or the overvoltage is minimized. Our next modification involves intelligent control of the voltage waveform. This may be done to minimize the magnitude or duration of the pulse, or to satisfy some other system constraint such as avoiding conditions that decrease reliability. Here, we present a method of using a high overvoltage to achieve a low coverage of CO on the anode and then a much smaller overvoltage to maintain a high hydrogen coverage and thus high current from the electrode. Over time, the hydrogen coverage may gradually degrade and the method may be repeated as needed.

The method uses a model based upon the coverage of the electrode surface with hydrogen (θ_{H}) and CO (θ_{co}). In the following sections, we present several mathematical techniques to (1) clean the surface of CO by raising the overvoltage to minimize the CO coverage and (2) maintain the surface at high hydrogen coverage by maximizing the hydrogen coverage. This two part optimization and control problem can be solved by many techniques. Below we illustrate the techniques of feedback linearization, sliding mode control, and optimal control by a series of examples.

### Example 1

### Feedback Linearization

The steps are as follows.
1. Develop a model for the fuel cell in question that relates the time derivative of θ_{H} and θ_{co} to the overvoltage. The model involves some unknown coefficients that must be found experimentally. For instance, scientists at Los Alamos National Laboratory have proposed the following model (T. E. Springer, T. Rockward, T. A. Zawodzinski, S. Gottesfeld, Journal of the Electrochemical Society, 148, A11-A23 (2001), which is incorporated by reference). The unknown coefficients are the k's and the b's, and η is the overvoltage

$$\begin{matrix}{\dot{θ}}_{CO} = {k}_{fc} {P}_{CO} ( 1 - {θ}_{CO} - {θ}_{H} ) - {b}_{fc} {k}_{fc} {θ}_{CO} - {k}_{ec} {θ}_{CO} {ⅇ}^{\frac{η}{{b}_{c}}} \\ {\dot{θ}}_{H} = {k}_{fH} {{P}_{H} ( 1 - {θ}_{CO} - {θ}_{H} )}^{2} - {b}_{fH} {k}_{fH} {θ}_{H}^{2} - 2 {k}_{eH} {θ}_{H} sinh ( \frac{η}{{b}_{H}} )\end{matrix}$$
2. Develop a model, called a set of observers that relates θ_{H} and θ_{co} to the measured current of the cell, j_{H}. The observer equations are numerically integrated in real time and will converge to the coverage values, θ_{H} and θ_{co}. The parameters I₁ and I₂ determine the rate of convergence.

$$\begin{matrix}{{θ}^{\dot{\hat{}}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {ⅇ}^{\frac{η}{{b}_{c}}} + {l}_{1} ( {θ}_{H} - {\hat{θ}}_{H} ) \\ {{θ}^{\dot{\hat{}}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - \\ 2 {k}_{eH} {\hat{θ}}_{H} sinh ( \frac{η}{{b}_{H}} ) + {l}_{2} ( {θ}_{H} - {\hat{θ}}_{H} ) \\ {θ}_{H} = \frac{{j}_{H}}{2 {k}_{eH} sinh ( \frac{η}{{b}_{H}} )}\end{matrix}$$
3. Develop a desired trajectory for the variation of θ_{co} and θ_{H} in time. This trajectory may be chosen to maximize durability of the cell, minimize the expected overvoltage changes, or for some other reason. That is, constraints 15 may be prescribed on any of the variables. In this example, we use a first order trajectory to reach the desired state values θ_{H}^{d} and θ_{co}^{d}.
   \dot{θ}_{H}=−α(θ_{H}−θ_{H}^{d})
   \dot{θ}_{co}=−β(θ_{co}−θ_{co}^{d})
4. Equate the time derivative of θ_{co} in the trajectory(3) to the time derivative of θ_{co} in the observer model (2). Equate the time derivative of θ_{H} in the trajectory(4) to the time derivative of θ_{H} in the observer model (2).

$$\begin{matrix}- β {\hat{θ}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {ⅇ}^{\frac{η}{{b}_{c}}} \\ - α {\hat{θ}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} )\end{matrix}$$
5. Solve for the overvoltage from the θ_{co} equation in (5).

$$η = ln ( \frac{- β ( {\hat{θ}}_{CO} - {\hat{θ}}_{CO}^{d} ) - {k}_{fc} {P}_{CO} ( 1 - {\hat{θ}}_{CO} - {\hat{θ}}_{H} ) + {b}_{fc} {k}_{fc} {\hat{θ}}_{CO}}{- {k}_{ec} {\hat{θ}}_{CO}} ) {b}_{C}$$
6. Solve for the overvoltage from the θ_{H} equation in (5).

$$η = {sinh}^{- 1} ( \frac{- α ( {\hat{θ}}_{H} - {\hat{θ}}_{H}^{d} ) - {k}_{fH} {{P}_{H} ( 1 - {\hat{θ}}_{CO} - {\hat{θ}}_{H} )}^{2} + {b}_{fH} {k}_{fH} {\hat{θ}}_{H}^{2}}{- 2 {k}_{eH} {\hat{θ}}_{H}} ) {b}_{H}$$
7. Vary the overvoltage according to 6 to drive θ_{co} to a desired value.
8. When θ_{co} reaches the desired value, vary the overvoltage according to 7 to drive θ_{H} to a desired value.
9. Repeat when needed.

The results of this example algorithm are shown in FIGS. 10A and 10B. FIG. 10A shows the overpotential as a function of time, with the overpotential high for about 13 seconds and low for the remaining time. FIG. 10B shows the coverage of CO being reduced from about 0.88 to 0.05 by applying step 5, followed by the coverage of hydrogen being increased from near zero to 0.95 by applying step 6. The hydrogen coverage will gradually degrade over time and the process will be repeated periodically.

### Example 2

### Sliding Mode Control

The exact feedback linearization technique presented above may not always be achievable due to the uncertainty of the model parameters (k's and b's). Therefore sliding mode control techniques can be applied to reduce sensitivity to the model parameters. The design procedure is as follows:
1. Develop a model, called a set of observers, that relates θ_{H} and θ_{co} to the measured current of the cell, j_{H}. The observer equations are numerically integrated in real time and will converge to the coverage values, θ_{H} and θ_{co}. The parameters I₁ and I₂ determine the rate of convergence.

$$\begin{matrix}{{θ}^{\dot{\hat{}}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {ⅇ}^{\frac{η}{{b}_{c}}} + {l}_{1} ( {θ}_{H} - {\hat{θ}}_{H} ) \\ {{θ}^{\dot{\hat{}}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - \\ 2 {k}_{eH} {\hat{θ}}_{H} sinh ( \frac{η}{{b}_{H}} ) + {l}_{2} ( {θ}_{H} - {\hat{θ}}_{H} ) \\ {θ}_{H} = \frac{{j}_{H}}{2 {k}_{eH} sinh ( \frac{η}{{b}_{H}} )}\end{matrix}$$
2. Develop a desired trajectory for the variation of θ_{co} and θ_{H} in time. This trajectory may be chosen to maximize durability of the cell, minimize the expected overvoltage changes, or for some other reason. That is constraints may be prescribed on any of the variables. In this example, we use a first order trajectory to lo reach the desired state values θ_{H}^{d} and θ_{co}^{d}.
   \dot{θ}_{H}=−α(θ_{H}−θ_{H}^{d})
   \dot{θ}_{co}=−β(θ_{co}−θ_{co}^{d})
3. Design the CO sliding surface as the CO coverage minus the integral of the desired state trajectory:
   S_{co}=\hat{θ}_{co}−∫β(\hat{θ}_{co}−θ_{co}^{d})
4. Design control as η=M*sign(S_{co}), where M is some constant used to enforce sliding mode.
5. After sliding mode exists the equivalent control is defined as:

$$η = ln ( \frac{- β ( {\hat{θ}}_{CO} - {\hat{θ}}_{CO}^{d} ) - {k}_{fc} {P}_{CO} ( 1 - {\hat{θ}}_{CO} - {\hat{θ}}_{H} ) + {b}_{fc} {k}_{fc} {\hat{θ}}_{CO}}{- {k}_{ec} {\hat{θ}}_{CO}} ) {b}_{C}$$
6. Design the H₂ sliding surface as the H₂ coverage minus the integral of the desired state trajectory
   S_{H}=\hat{θ}_{H}−∫α(\hat{θ}_{H}−θ_{H}^{d})
7. Design control as η=M*sign(S_{H}), where M is some constant used to enforce sliding mode.
8. After sliding mode exists the equivalent control is defined as:

$$η = {sinh}^{- 1} ( \frac{- α ( {\hat{θ}}_{H} - {\hat{θ}}_{H}^{d} ) - {k}_{fH} {{P}_{H} ( 1 - {\hat{θ}}_{CO} - {\hat{θ}}_{H} )}^{2} + {b}_{fH} {k}_{fH} {\hat{θ}}_{H}^{2}}{- 2 {k}_{eH} {\hat{θ}}_{H}} ) {b}_{H}$$
9. Vary the overvoltage according to 4 to drive θ_{co} to a desired value.
10. When θ_{co} reaches the desired value, vary the overvoltage according to 7 to drive θ_{H} to a desired value.
11. Repeat when needed.

### Example 3

### Optimal Control

Optimal control can also be implemented to minimize the power applied to the cell used to stabilize the hydrogen electrode coverage, hence maximizing the output power of the cell. The steps are as follows:
1. Develop a model, called a set of observers, that relates θ_{H} and θ_{co} to the measured current of the cell, j_{H}. The observer equations are numerically integrated in real time and will converge to the coverage values, θ_{H} and θ_{co}. The parameters I₁ and I₂ determine the rate of convergence.

$$\begin{matrix}{{θ}^{\dot{\hat{}}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {ⅇ}^{\frac{η}{{b}_{c}}} + {l}_{1} ( {θ}_{H} - {\hat{θ}}_{H} ) \\ {{θ}^{\dot{\hat{}}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - \\ 2 {k}_{eH} {\hat{θ}}_{H} sinh ( \frac{η}{{b}_{H}} ) + {l}_{2} ( {θ}_{H} - {\hat{θ}}_{H} ) \\ {θ}_{H} = \frac{{j}_{H}}{2 {k}_{eH} sinh ( \frac{η}{{b}_{H}} )}\end{matrix}$$
2. Develop a cost function used to minimize the power applied to the cell as the CO coverage is driven to the desired value θ_{co}^{d}. Where A and B are the weights and T₁ is the time interval for the CO control to be applied.

$${\int }_{0}^{{T}_{1}} ( {A ( {\hat{θ}}_{CO} - {θ}_{CO}^{d} )}^{2} + B {η}^{2} ) ⅆ t$$
3. Solve for the overvoltage to drive CO to the desired value by applying dynamic programming techniques as described in Kirk, Donald E., Optimal Control Theory, Englewood Cliffs, N. J., Prentice Hall Inc., 1970. Apply the overvoltage for time zero at the lower limit of integration.
4. Develop a cost function used to maximize the power output of the cell as the H₂ coverage is driven to the desired value θ_{H}^{d}. Where A and B are the weights and T₂-T₁ is the time interval for the hydrogen control to be applied.

$${\int }_{{T}_{1}}^{{T}_{2}} ( {A ( {\hat{θ}}_{H} - {θ}_{H}^{d} )}^{2} - {B ( {E}_{0} - η )}^{2} {I}^{2} ) ⅆ t$$
5. Solve for the overvoltage as in step 3. Apply the overvoltage for time T₁ to T₂.
6. Repeat as necessary.
   A Feedback Control Technique Based Upon Natural Oscillations in Fuel Cell Voltage to Clean the Electrode

It has been known for some time that some electrodes, when operated as an anode with hydrogen and carbon monoxide, can result in an oscillating current or voltage. In fact this has been known for other competing reactions on electrodes as well. One explanation of this effect is as follows for a system operated at constant current. On an initially clean electrode, the hydrogen reacts and the carbon monoxide begins to poison the surface, resulting in an increasing overvoltage. At a certain overvoltage, the CO is oxidized to CO₂ and the poison is removed, decreasing the overvoltage back to nearly the original, clean surface value. Deibert and Williams (“Voltage oscillations of the H2/CO system”, J. Electrochemistry Soc., 1969) showed that these voltage oscillations were quite strong at levels of CO of 10,000 ppm or 1 per cent. However, the oscillations disappeared when the system was operated at 5 per cent CO.

Since 1 per cent is the approximate concentration of CO from a reforming reaction in a fuel cell, taking advantage of these natural oscillations to periodically clean the electrode is a powerful advantage, eliminating the need for reducing the CO to the 10-50 ppm now required by fuel cell manufacturers. Furthermore, operation of a fuel cell at CO levels higher than 1 per cent and observing the natural oscillations is previously unknown and enables the advantages previously mentioned for high CO level operation.

By using a feedback control system to operate the fuel cell at constant current with levels of CO higher than 1 per cent in the fuel, and letting the control system vary the anode voltage to maintain the constant current output, enhanced performance can result.

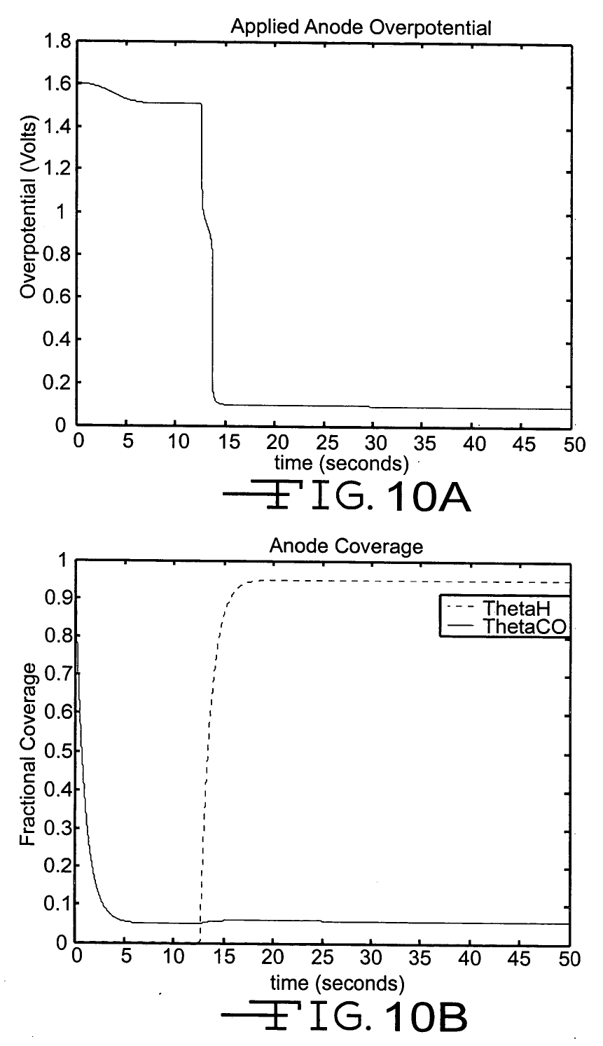

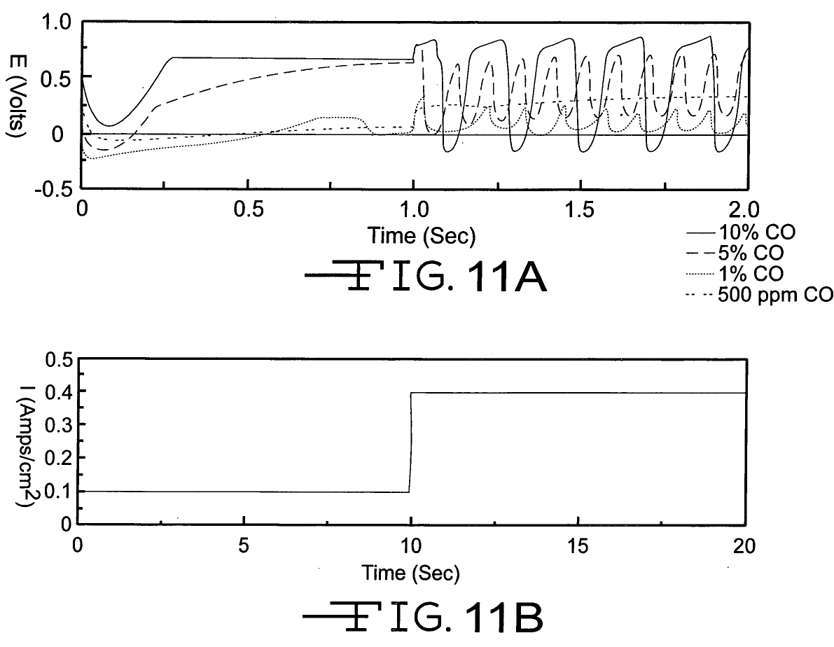

FIGS. 11A and 11B show data obtained in our laboratory using the same 5 cm2 fuel cell described in the earlier paragraphs. These data were obtained at constant current operation a PAR Model 273 Potientostat operated in the galvanostatic mode. Hydrogen fuel was used with four different levels of CO: 500 ppm CO, 1 per cent, 5 per cent and 10 per cent. The figures show that when the current is increased to 0.4 amps and the concentration of CO is 1 per cent or greater, the cell voltage begins to oscillate with an amplitude that is consistent with the amplitudes expected for CO oxidation. Furthermore, the amplitude increases as the CO level in the fuel increases.

In this application, we first describe a method of maintaining a constant current by varying the voltage similar to FIG. 11A. Next we describe using this system to follow a varying current of power.

To accomplish this, a feed back control system is used to measure the current of the fuel cell, compare it to a desired value and adjust the waveform of the anode voltage to achieve that desired value. Essentially, this will reproduce a voltage waveform similar to FIG. 11A.

The controller to be used is any control algorithm or black box method that does not necessarily require a mathematical model or representation of the dynamic system as described in Passino, Kevin M., Stephen Yurkovich, Fuzzy Control, Addison Wesley Longman, Inc., 1998. The control algorithm may be used in accordance with a voltage following or other buffer circuit that can supply enough power to cell to maintain the desired overpotential at the anode. Because the voltage follower provides the power, the controller may be based upon low power electronics. However, in some cases it may be more advantageous to not incorporate the voltage follower in the control circuit, since in some cases external power will not be required to maintain the overvoltage.

The resulting output of the controller will be similar to that in FIGS. 11A and 11B, with the addition of a voltage boosting circuit the cell may be run at some desired constant voltage or follow a prescribed load.

In some cases, the natural oscillations of voltage may be maintained by providing pulses of the proper frequency and duration to the anode or cathode of the device to excite and maintain the oscillations. Since this is a nonlinear system, the frequency may be the same as or different from the frequency of the natural oscillations. The pulsing energy may come from an external power source or from feeding back some of the power produced by the fuel cell. The fed back power can serve as the input to a controller that produces the pulses that are delivered to the electrode.

The present invention is contemplated for use with fuel cell systems as well as other systems including apparatuses used in electrochemical processes. By way of example and not limitation, the types of fuel cells include PEM fuel cells, direct methanol fuel cells, methane fuel cells, propane fuel cells, solid oxide fuel cells, and phosphoric acid fuel cells.

Fuel Cell Systems Including Fuel Cells Having Improved Polymer Electrolyte Membranes

The present invention also relates to fuel cell systems including fuel cells having improved polymer electrolyte membranes. The membranes are usually made from hydrocarbon-based polymers instead of the conventional fluorinated polymers. The membranes usually are reduced in cost, can operate at higher temperatures, and have reduced water management and carbon monoxide issues compared to membranes made with the fluorinated polymers operating at less than 100° C.

Membranes Made with Hydrocarbon-Based Polymers Having Acidic Groups on Side Chains

In one embodiment of the invention, the polymer electrolyte membrane is made from a hydrocarbon-based polymer having acidic groups on side chains of the polymer. By “hydrocarbon-based” is meant that the polymer consists predominantly of carbon and hydrogen atoms along its backbone, although other atoms can also be present. The acidic groups are not attached directly to the backbone of the polymer, but rather are attached to side chains that extend from the backbone. Preferably, the acidic groups are attached to atoms on the side chains that are between 1 and 12 atoms away from the backbone, and more preferably between 4 and 10 atoms away is from the backbone. By “attached to the side chains” is meant that at least about 65% by weight of the acidic groups are attached to the side chains, preferably at least about 75%, more preferably at least about 85%, and most preferably substantially all the acidic groups are attached to the side chains.

Any suitable acidic groups can be used for making the polymers, such as sulfonate groups, carboxylic acid groups, phosphonic acid groups, or boronic acid groups. Mixtures of different acidic groups can also be used. Preferably, the acidic groups are sulfonate groups.

Any suitable hydrocarbon-based polymer can be used in the invention.

Preferably, the polymer has a weight average molecular weight of at least about 20,000. The polymer is usually stable at temperatures in excess of 100° C. Preferably, the polymer has a glass transition temperature of at least about 100° C., and more preferably at least about 120° C. In some embodiments, the polymer is selected from sulfonated polyether ether ketones (PEEK), sulfonated polyether sulfones (PES), sulfonated polyphenylene oxides (PPO), sulfonated lignosulfonate resins, or blends thereof. These categories of polymers include substituted polymers; for example, sulfonated methyl PEEK can be used as well as sulfonated PEEK.

The polymers can be prepared either by adding acidic groups to the polymers, or by adding acidic groups to monomers or other subunits of the polymers and then polymerizing the subunits. Following is a representative method of preparing a sulfonated side chain methyl PEEK by first preparing the polymer and then sulfonating the polymer. First, methyl PEEK is prepared as follows (this is described in U.S. Pat. No. 5,288,834, incorporated by reference herein): 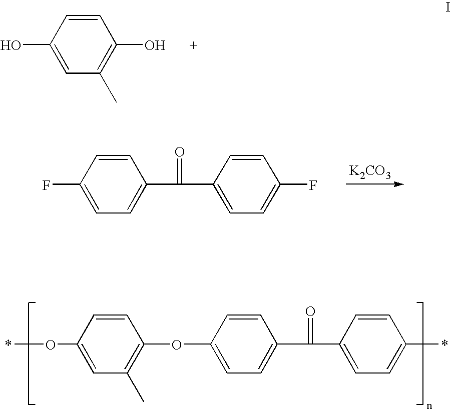
Then, methyl side chains of the methyl PEEK are first brominated and then sulfonated as follows (the synthesis of II is described in U.S. Pat. No. 5,288,834):

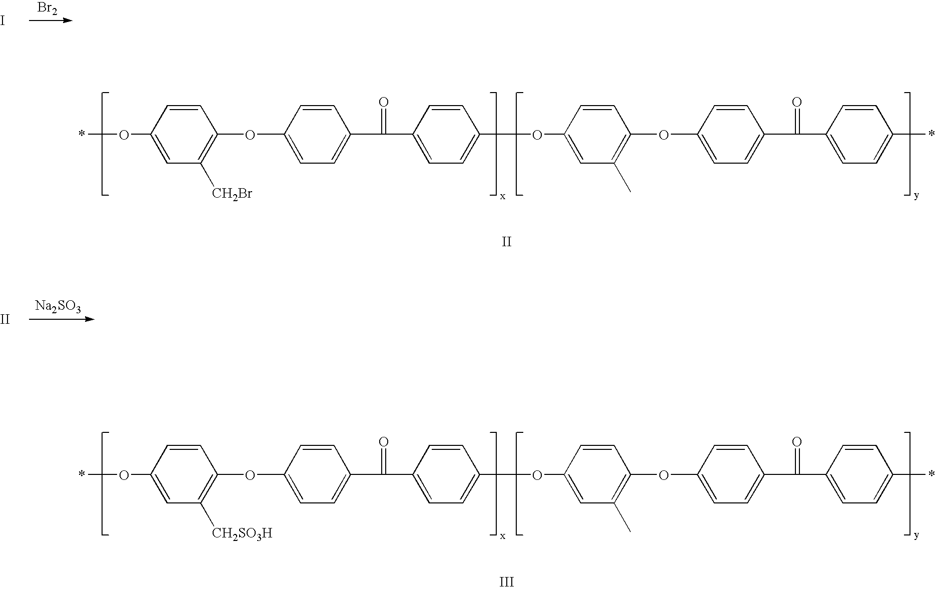

Any suitable sulfonation reaction procedure can be used to synthesize III from II. In one representative procedure, 0.50 g of monobromomethyl PEEK (II) was dissolved in 10 ml of N-methylpyrrolidinone with 0.30 g of sodium sulfite. The solution was heated at 70° C. for 16 hours. After allowing to cool to room temperature, the polymer solution was poured into 50 ml of water. The precipitate was collected on a membrane filter and washed with water and dried at 70° C. for 16 hours under vacuum. The yield was 0.46 g (98%).

Following is a representative method of first preparing sulfonated side chain monomers and then polymerizing the monomers to make a sulfonated side chain PEEK homopolymer. The length of the aliphatic chain is controlled by the use of different α,ω-dibromoalkanes (e.g. 1,4-dibromobutane, 1,6-dibromohexane, 1,12-dibromododecane, etc.) during the first synthetic step.

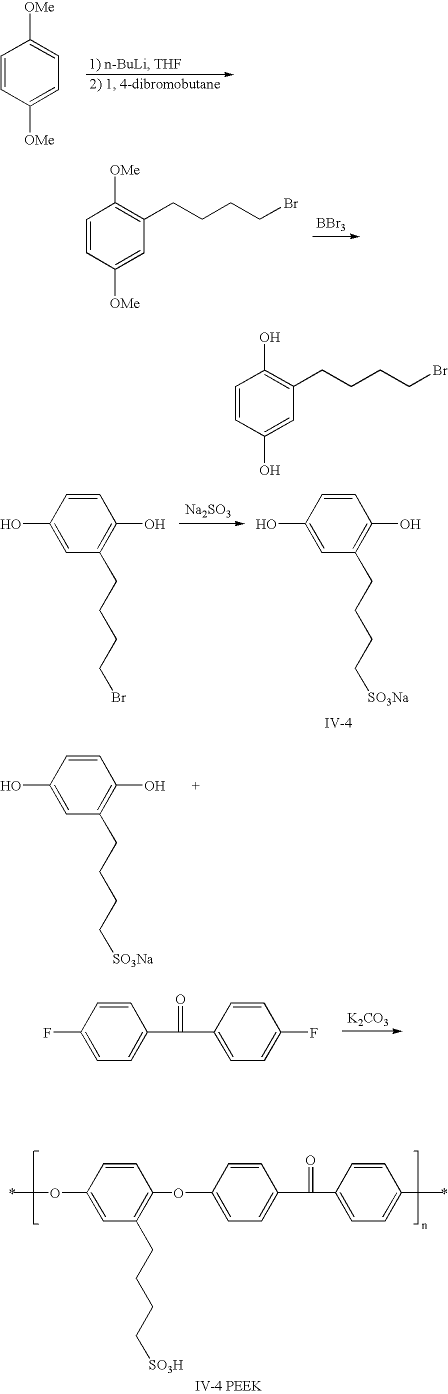

Any suitable reaction procedure can be used to synthesize IV-4. In one representative procedure, 1.01 g of 2-(4-bromobutyl)-1,4-dihydroxybenzene was dissolved in 10 ml of N,N-dimethylformamide with 1.00 g of sodium sulfite and stirred at room temperature for 1 hour. The reaction mixture was then precipitated into 50 ml of water and extracted with diethyl ether (3×50 ml). The extracts were washed with water (3×25 ml), dried over magnesium sulfate and the solvent removed under vacuum.

Following is a representative method of preparing a sulfonated side chain PEEK copolymer. The amount of sulfonate in the final polymer can be controlled by forming copolymers with hydroquinone (and also methyl hydroquinone from the synthesis of I).

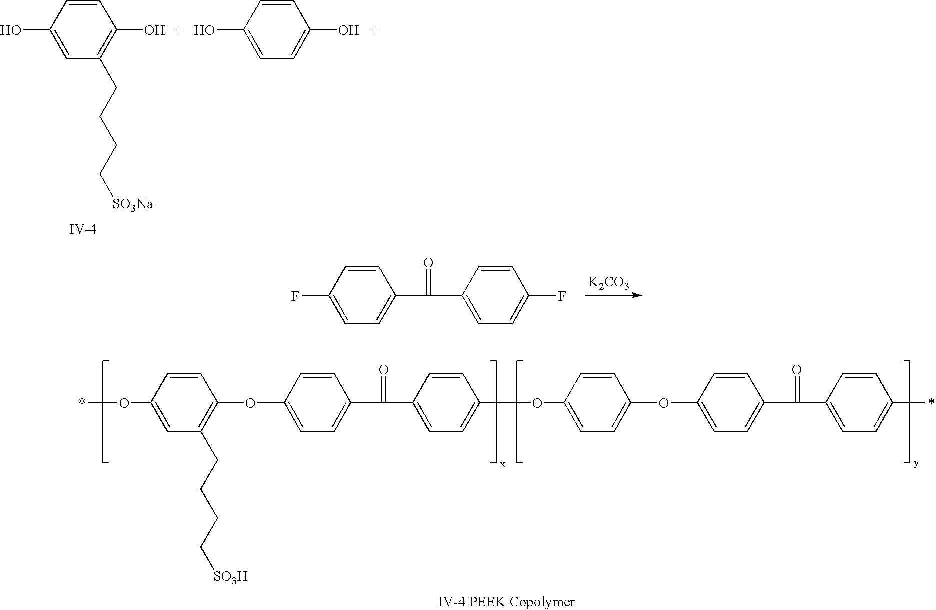

The following sulfonated side chain monomers may be prepared according the synthesis outlined above for IV-4 by utilizing different starting materials. In some preferred embodiments of the invention, the side chains are aliphatic hydrocarbon chains, such as those shown below. The monomers can then be polymerized into sulfonated side chain polymers as described above.

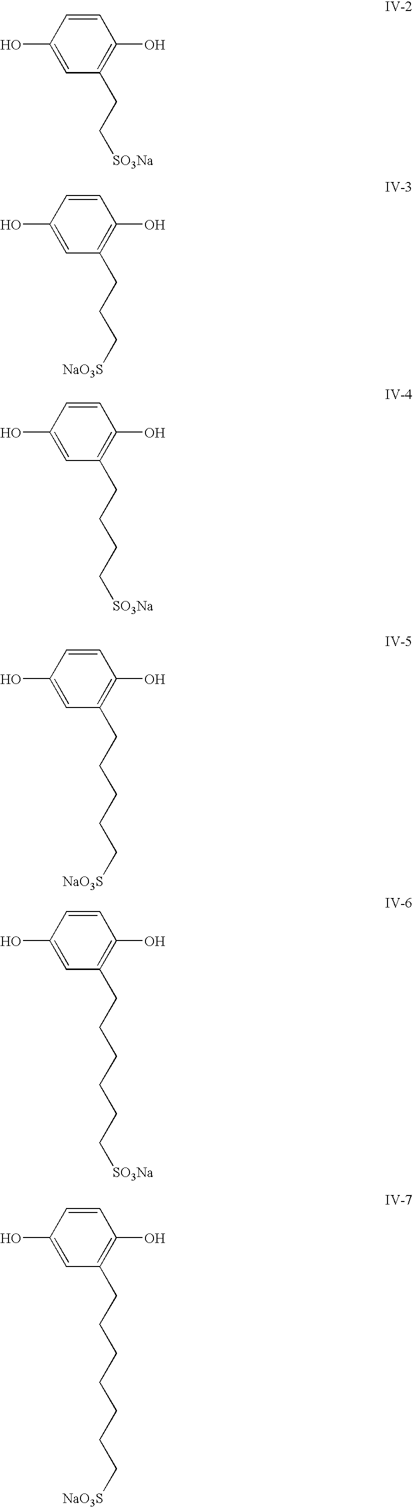

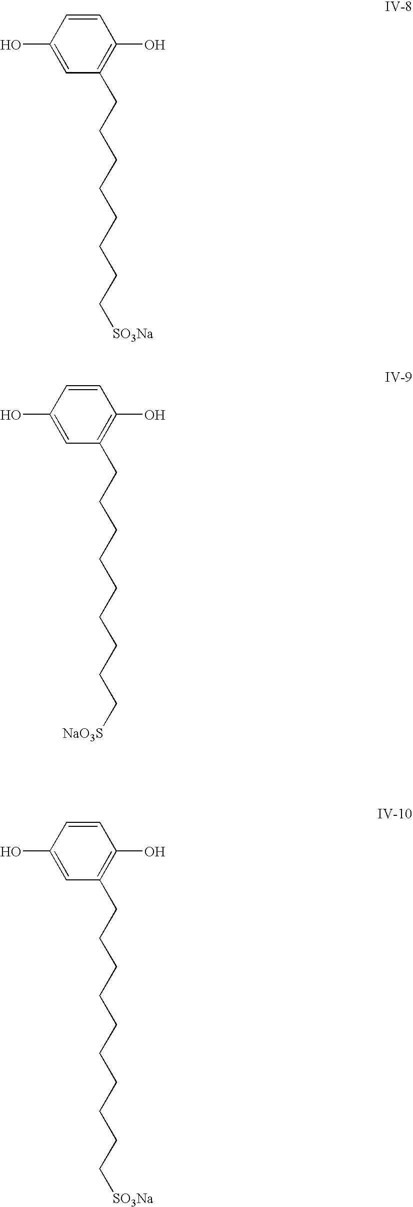

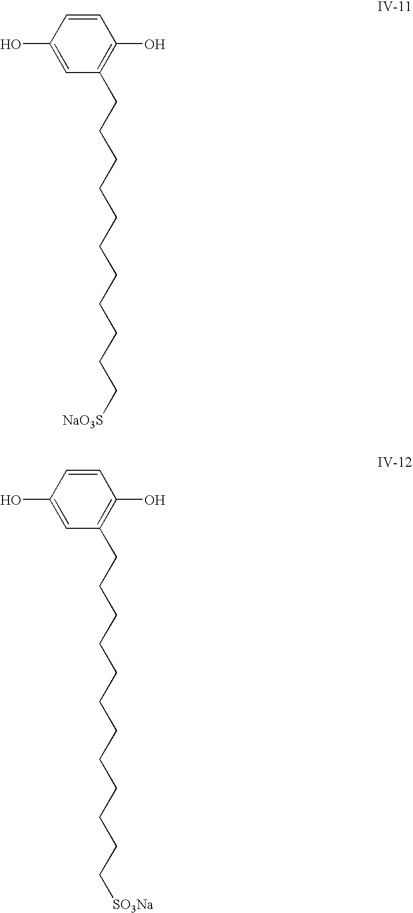

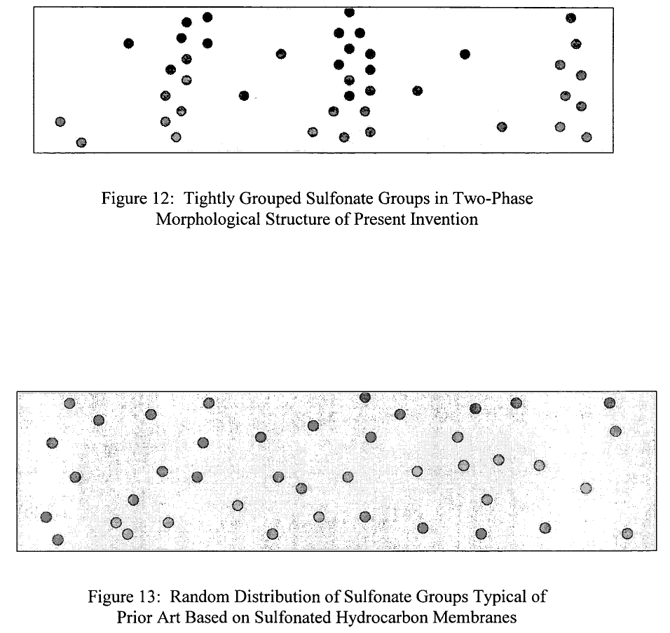

While not intending to be limited by theory, it is believed that the hydrocarbon-based polymers having acidic groups on side chains usually have a phase separated morphological microstructure that increases their proton conductivity (measured as ionic conductivity). The polymers have different concentrations of groups in different areas of the membrane, not a uniform mixture all the way through the polymer. It is believed that the length of the side chains is sufficient to allow for phase separation of the acidic groups, with these groups forming small channels in the bulk of the polymer. The proton conduction is believed to take place primarily inside these channels. FIG. 12 is a representation of the phase separated morphology of the sulfonated side chain polymers, with the sulfonate groups shown as dots and the remainder of the polymer shown as a gray background. It is seen that the sulfonate groups are tightly grouped together, leaving channels between the groups that leads to an enhancement of the proton conductivity. In contrast, FIG. 13 is a representation of a typical sulfonated hydrocarbon-based polymer in which the sulfonate groups are attached to the backbone instead of to side chains on the polymer. It is seen that the sulfonate groups are relatively uniformly distributed throughout the polymer, so that channels are not formed between the groups as in FIG. 12. The lack of a phase separated morphological microstructure results in lower proton conductivity.

More generally, the present invention relates to any polymer electrolyte membrane comprising a proton conducting hydrocarbon-based polymer membrane having a phase separated morphological microstructure. Preferably, the phase separated morphology is provided by the polymer having a backbone and having acidic groups on side chains attached to the backbone. In addition to sulfonate groups, any other suitable acidic groups can be attached to the polymer side chains, such as those described above.

The invention also relates in general to any polymer electrolyte membrane comprising a proton conducting polymer membrane having a phase separated morphological microstructure, where the polymer has a glass transition temperature of at least about 100° C., and preferably at least about 120° C. Any polymer having these properties can be used in the invention. Some nonlimiting examples of polymers that can be suitable are sulfonated aromatic or alicyclic polymers, and sulfonated organic or inorganic hybrids such as sulfonated siloxane-containing hybrids and sulfonated hybrids containing Siloxirane® (pentaglycidalether of cyclosilicon, sold by Advanced Polymer Coatings, Avon, Ohio). The polymer membranes of the invention can operate at higher temperatures than conventional fluorinated polymer membranes.

The high temperature operating ability of the polymer electrolyte membranes helps them to retain most of their ionic conductivity at high temperatures. This is in contrast with Nafion™ membranes, which have significantly reduced ionic conductivity at high temperatures. Preferably, a membrane according to the invention does not lose more than about 5% of its maximum ionic conductivity when operated in a fuel cell at a temperature of 100° C., and does not lose more than about 25% of its maximum ionic conductivity when operated in a fuel cell at a temperature of 120° C.

While the phase separated morphology of the polymer electrolyte membrane increases its ionic conductivity, the morphology does not cause an undesirable electroosmotic drag in the membrane. In a Nafion™ membrane, the protonic current through the membrane produces an electroosmotic water current in the same direction that leads to a depletion of water at the anode. This results in an increased membrane resistance, i.e., a reduced fuel cell performance. The electroosmotic drag coefficient, K_{drag}, is defined as the number of water molecules transferred through the membrane per proton in the case of a vanishing gradient in the chemical potential of H₂O, and it can be measured by an electrophoretic NMR as described in the article “Electroosmotic Drag in Polymer Electrolyte Membranes; an Electrophoretic NMR Study” by M. Ise et al., Solid State Ionics 125, pp. 213-223 (1999). At the same ionic conductivity and the same temperature, the polymer electrolyte membranes of the invention usually have a lower electroosmotic drag coefficient than a Nafion™ membrane.

The polymer electrolyte membrane can optionally contain one or more additives that aid in controlling the morphology of the membrane for increased proton conductivity. Any suitable additives can be used for this purpose. Some nonlimiting examples of additives that can be suitable include interpenetrating polymer networks and designed polymer blends. Some typical polymer blend compositions to effect a desired morphology are phenolics and polyimides. These polymers can be slightly or fully sulfonated and used in combination with the hydrocarbon-based polymers mentioned above at low to medium levels (preferably from about 10% to about 30% of total polymer composition). One example of a phenolic resin is a lignin derived phenolic having good high temperature properties.

The polymer electrolyte membrane can also optionally contain one or more additives that improve the membrane by increasing its hydratability and/or increasing its ionic conductivity. Any suitable additives can be used for this purpose. Some nonlimiting examples of additives that can be suitable include highly hydrated salts and heteroatom polyacids that retain their water of hydration at high temperature and promote high electron conductivity at high temperature. Examples of suitable additives include imidazole, substituted imidazoles, lignosulfonate, cesium hydrosulfate, zirconium oxy salts, tungsto silisic acid, phosphotungstic acid, and tungsten-based or molybdenum-based heteroatom polyacids such as polytungstic acid.

Membranes Made from Acidic and Basic Materials

In another embodiment of the invention, the polymer electrolyte membrane is made from an acidic hydrocarbon-based polymer or oligomer, or blends thereof, in combination with a basic material. The acid/base interaction is primarily responsible for the proton conduction in such membranes, particularly at high temperatures. The membranes do not depend on water for proton conduction; as a result, the membranes have reduced water management issues.

Any suitable acidic polymer or oligomer can be used to make the membrane. Preferably, the acidic polymer is a sulfonated hydrocarbon-based polymer, although other acidic polymers can be used, such as carboxylated, phosphonated, or boronic acid-containing polymers. In some embodiments, the polymer is selected from sulfonated polyether ether ketones, sulfonated polyether sulfones, sulfonated polyphenylene oxides, sulfonated lignosulfonate resins, or blends thereof. The acidic groups can be added on either the backbone or side chains of the polymer in this embodiment of the invention.

Any suitable basic material can be used to make the membrane. Preferably, the basic material is a non-polymeric material. In some embodiments, the basic material is a heterocyclic compound such as imidazole, pyrazole, triazole or benzoimidazole. Other basic materials could also be used, such as substituted imidazoles (e.g., short chain polyethyleneoxide terminated imidazole groups), pyrrolidones, oxazoles, or other basic amine compounds. Preferably, the basic material is present in an amount of not more than about 30% by weight of the polymer.

The polymer electrolyte membrane can optionally contain one or more additives to further enhance its ionic conductivity, such as the additives described above.

Table 1 lists some membrane formulations, with “Base System” referring to an acidic hydrocarbon-based polymer or polymer blend. “SPEEK” refers to sulfonated polyether ether ketone having sulfonate groups attached to the aromatic groups of the polymer backbone. The SPEEK was synthesized in a 36-hour, room temperature sulfonation reaction. “SPES” refers to sulfonated polyether sulfone having sulfonate groups attached to the aromatic groups of the polymer backbone. The SPES was synthesized in a 24-hour, room temperature sulfonation reaction. “SPEEK/SPES” refers to a 50/50 blend by weight of SPEEK and SPES. Some of the formulations contain the additives PWA (phosphotungstic acid), imidazole, and a polymer gel (which is discussed below).

TABLE 1
Material Formulation Matrix

| | | PWA (wt % | Gel (wt % | Imidazole (wt % |
|---|---|---|---|---|
| Sample | Base System | wrt base) | wrt base) | wrt base) |
| 1 | SPEEK | | | |
| 2 | SPEEK | 10 | | |
| 3 | SPEEK | | 10 | |
| 4 | SPEEK | | | 7.5 |
| 5 | SPEEK | 10 | 10 | |
| 6 | SPEEK | 10 | | 7.5 |
| 7 | SPEEK | | 10 | 7.5 |
| 8 | SPES | | | |
| 9 | SPEEK/SPES | | | |
| 10 | SPEEK/SPES | 10 | | |

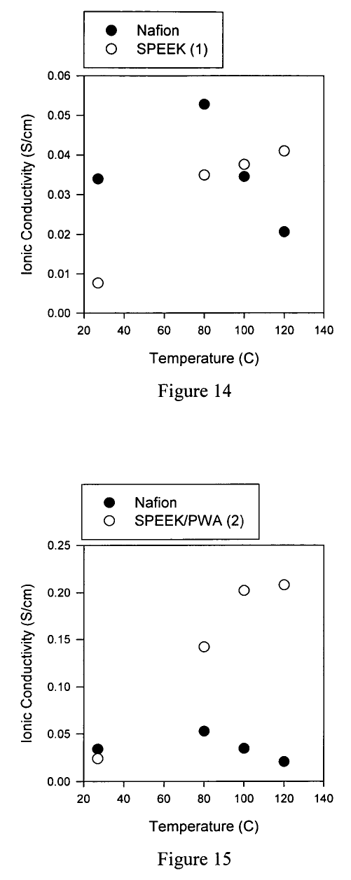

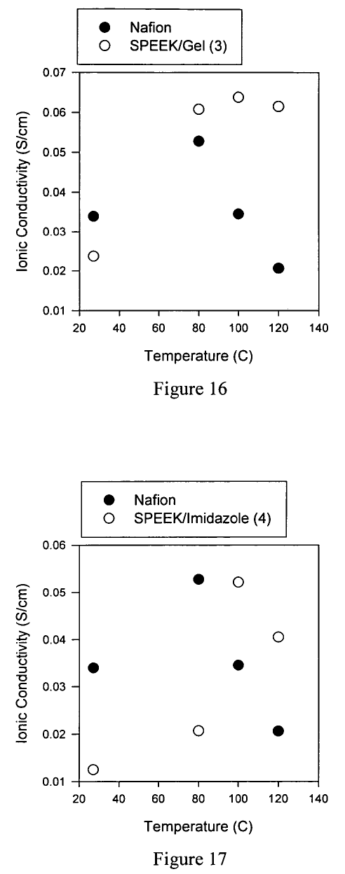

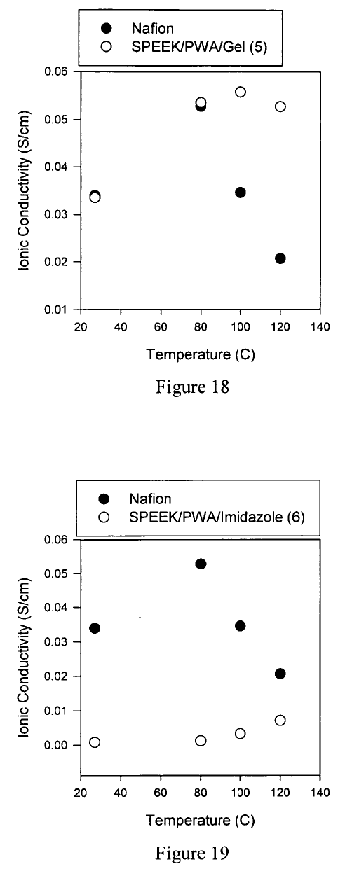

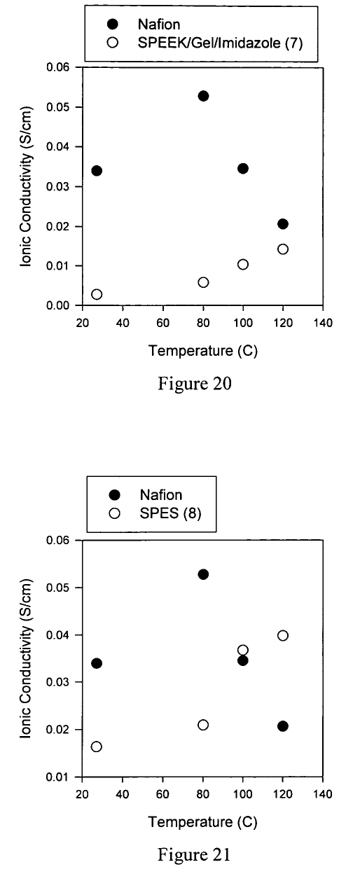

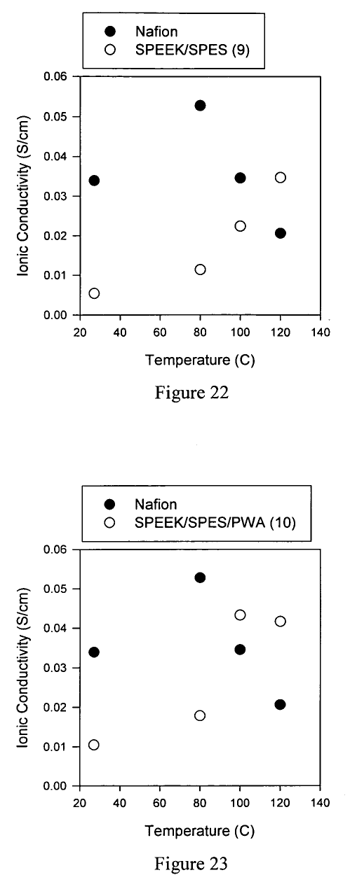

The ionic conductivity plots corresponding to samples 1-10 in the table are shown in FIGS. 14-23, respectively. The conductivity plots of the sample membranes are shown in comparison with a conductivity plot of a Nafion™ membrane. These plots display ionic conductivity (S/cm) versus temperature (° C.) in a saturated environment. For 8 of the 10 material systems, there is a marked improvement over Nafion™ at 120° C. Of the two remaining material systems, there is a stable trend in ionic conductivity which is independent of temperature that is similar to the performance of Nafion™ at 120° C.

In another embodiment of the invention, the polymer electrolyte membrane is made from a blend of different polymers, in combination with one or more additives that aid in controlling the morphology of the membrane for increased proton conductivity, or in combination with one or more additives that improve the membrane by increasing its hydratability and/or increasing its ionic conductivity. Such additives are described above. Any suitable polymers can be used in the blends. Preferably, the blends are a blend of different hydrocarbon-based polymers, or a blend of a hydrocarbon-based polymer and a Nafion™ polymer.

Membranes Made from Solid Polymer in Combination with Gel Polymer

In another embodiment of the invention, the polymer electrolyte membrane is made from a solid hydrocarbon-based polymer in combination with a gel hydrocarbon-based polymer, the solid and gel polymers having acidic groups such as described above. The membranes made with the blend of solid and gel polymers are usually low cost and typically outperform Nafion™ membranes at high temperatures (e.g., above about 100° C.). In some embodiments, the solid polymer and the gel polymer are both selected from sulfonated polyether ether ketones, sulfonated polyether sulfones, sulfonated polyphenylene oxides, sulfonated lignosulfonate resins, or blends thereof. Preferably, the amount of gel polymer is from about 1% to about 30% by weight of the solid polymer.

Any suitable methods can be used for preparing the solid and gel polymers, and for preparing the membranes from the polymer blends. With respect to PEEK, the PEEK powder is typically placed in a reaction vessel with sulfuric acid for times less than or equal to 18 hours and greater than or equal to 36 hours at room temperature. 18-hour sulfonations produce systems which are inherently stable in water, while the 36-hour sulfonations eventually become water soluble. There are two methods which promote water-soluble gel formation in the 36-hour systems. One approach is to improperly wash the system from free acid. This will produce a sulfonated PEEK/water slurry which is acidic (pH about 3-4). This slurry is then left on a lab bench at room temperature for days (20-30) until water solubility is apparent. A second approach is to accelerate gel formation by using an autoclave. Using this method, a 36-hour batch is washed to acidic pH similarly to the first method, but the remaining slurry is placed in the autoclave at 150° C., 15 psi, for 3 hours. This method will also produce a water-soluble gel. The gels can then be blended with the 18-hour sulfonated powders, which have been thoroughly washed of free acid. Regardless of the method used, a film can be drawn down with an application bar and applied to a substrate which provides for a free-standing film. Once a film is created from the 18-hour sulfonated PEEK and the 36-hour gels, the material is no longer water soluble.

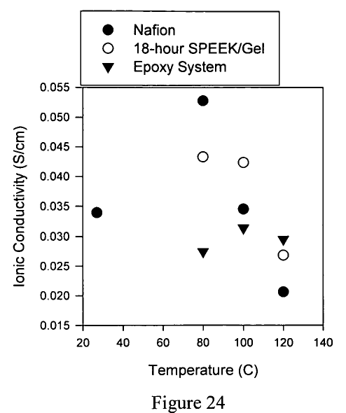

FIG. 24 shows an ionic conductivity plot of a polymer electrolyte membrane made from a blend of solid SPEEK and 10% gel SPEEK (by weight of the solid). This figure displays ionic conductivity (S/cm) versus temperature (° C.) in a saturated environment as compared to Nafion™. It is seen from this figure that the ionic conductivity of the 18-hour SPEEK/Gel membrane outperforms Nafion™ at 100° C. and 120° C.

Samples 3, 5 and 7 in Table 1 were made from a blend of a solid SPEEK and a gel SPEEK. The gel SPEEK was prepared by sulfonating PEEK to a higher degree of sulfonation than the solid SPEEK, which promotes the onset of gel formation (i.e. water solubility). As seen in the corresponding conductivity plots in FIGS. 5, 7 and 9, two noticeable improvements are evident from the data. One is seen in FIGS. 5 and 7 where the SPEEK/Gel systems (both with and without the PWA additive) show marked improvement over Nafion™ at temperatures of 80° C., 100° C. and 120° C. The second improvement is noticeable in FIG. 9 where the SPEEK/Gel/Imidazole system shows improved performance as temperature increases approaching that of the performance of Nafion™ at 120° C.

Membranes Made from Epoxy Polymer and Nitrogen-Containing Compound

In another embodiment of the invention, the polymer electrolyte membrane is made from a combination of an epoxy-containing polymer and a nitrogen-containing compound. The membranes are usually low cost and typically outperform Nafion™ membranes at high temperatures (e.g., above about 110° C.). Any suitable epoxy-containing polymer can be used to make the membrane. Preferably, the epoxy-containing polymer is an aromatic epoxy resin. Any suitable nitrogen-containing compound can be used to make the membrane. Preferably, the nitrogen-containing compound is imidazole or a substituted imidazole. In one embodiment, the membrane comprises from about 20% to about 95% epoxy resin and from about 5% to about 30% imidazole or substituted imidazole by weight. In many embodiments, the nitrogen-containing compound is a curing agent for the epoxy resin. Imidazole and substituted imidazoles act as curing agents, as well as increasing proton conduction. Other suitable curing agents include various diamines of primary and secondary amines.

The membrane can also optionally contain one or more additives that improve the membrane by increasing its hydratability and/or increasing its ionic conductivity, such as those described above (e.g., lignosulfonate or highly hydratable polyacids); one or more additives that aid in controlling the morphology of the membrane, such as those described above; and one or more high temperature polymers, such as sulfonated Siloxirane®. Sulfonated hydrocarbon-based polymers could also be added, such as SPEEK or SPES.

A preferred membrane according to the invention contains 55.65% Epon 813, 10.53% Admex 760, 1.04% FC4430, 17.69% imidazole (40% in N-methyl-pyrrolidone), 7.12% phosphotungstic acid (25% in N-methylpyrrolidone), and 7.97% Epicure 3200 (all by weight of the membrane). Epon 813 (Shell) is an epichlorhydrin bis phenol A epoxy resin modified with various heloxy resins. Admex 760 (Velsicol Chemical Corporation) is a polymeric adipate (esters of adipic acid) and functions as a plasticizer. FC4430 is a 3M product containing a fluoride and functions as a flow control agent. Epicure 3200 is an aliphatic amine curing agent. The order of addition is as listed above, and attention is given to the time frame within which one is working after the addition of the curing agent. The pot life in this case is about 2 to 3 hours depending on ambient conditions with a cure schedule of 30 minutes at 120° C. A film is drawn down with an 8 mil wet application bar, and applied to a substrate which provides for a free-standing film.

FIG. 13 shows an ionic conductivity plot of the preferred epoxy membrane system. This figure displays ionic conductivity (S/cm) versus temperature (° C.) in a saturated environment as compared to Nafion™. It is seen from this figure that the ionic conductivity of the epoxy membrane outperforms Nafion™at 120° C. with a is potential trend towards stability at temperatures above 100° C.

Membrane Electrode Assemblies

The present invention also relates to fuel cells systems having membrane electrode assemblies including the polymer electrolyte membranes of the invention. The membrane electrode assembly includes the polymer electrolyte membrane, a first catalyst layer positioned on a first side of the membrane, a second catalyst layer positioned on a second side of the membrane, an anode positioned outside the first catalyst layer, and a cathode positioned outside the second catalyst layer. The catalyst layers can be coated on the inside surfaces of the anode and the cathode, or on opposing sides of the membrane. The invention also relates to a fuel cell stack which comprises a plurality of membrane electrode assemblies and flow field plates between the assemblies.

Direct Methanol Fuel Cells

The present invention also relates to fuel cell systems having direct methanol fuel cells (DMFCs) including the polymer electrolyte membranes of the invention. There is a need for a polymer electrolyte membrane that can function effectively in a DMFC, as the current membranes are deficient in preventing crossover of methanol across the membrane from anode to cathode. This limits the level of methanol that can be used as the hydrogen source to less than about 1-2 M concentration. It is estimated that a much higher concentration of methanol (in the range of 10 M) would be needed for a DMFC to have sufficient power density for use in many applications of interest. The polymer electrolyte membranes of the invention are expected to function as effective and efficient membranes in a DMFC with reduced methanol crossover.

In a preferred embodiment, the polymer electrolyte membranes are able to operate at a higher temperature (e.g., 120°-150° C.) than Nafion™ membranes so that the oxidation kinetics of methanol at the anode are significantly enhanced. This results in a lower concentration of unreacted methanol in the feed, and it allows operation of a DMFC at higher methanol concentration with reduced tendency for crossover. Operating at a higher temperature is also expected to allow the use of a lower level of catalyst (platinum/ruthenium or platinum/molybdinum) with significant reduction in cost. At the higher temperature, methanol can be fed in the vapor phase; this should also decrease any crossover problems by increasing the reaction kinetics.

Preferably, the polymer used in the polymer electrolyte membrane has a glass transition temperature of at least about 100° C., and more preferably at least about 120° C., to enable the higher operating temperature. Some examples of high temperature polymers are described above.

### EXAMPLES

Polymer electrolyte membranes made with an acidic hydrocarbon-based polymer (e.g., sulfonated polyether sulfone), imidazole and additives according to the invention were synthesized and tested as follows:

Polymer Synthesis: Concentrated sulfuric acid (H₂SO₄) is placed in a boiling flask containing a magnetic stirrer bar. The flask is then placed on a magnetic stirrer. While stirring, the appropriate amount of polymer powder (e.g. polyethersulfone (PES)) is slowly added in order to produce a miscible solution with minimal conglomeration. The approximate ratio of PES:H₂SO₄ is 5 g:50 mL. The sulfonation solution is allowed to stir for a desired reaction time (1-96 hours) at a desired reaction temperature (23° C. or 80° C.). The mixture is then transferred to a separatory funnel.

Once in the separatory funnel, the solution is precipitated dropwise into a 1000 ml beaker containing deionized water (DI H₂O), which is also stirring on a magnetic stirrer plate. This precipitation procedure forms pellets of sulfonated polymer. The pellets are then washed with DI H₂O via vacuum filtration until the pH of the filtrate is ˜5. Finally, the synthesized pellets are immersed in a glass vial filled with DI H₂O and placed on rollers for an extended period of time (4 to 24 hours). Once the pellets are removed from the rollers, they are transferred to open-faced petri dishes. These dishes are then inserted into an oven at 50-80° C. for 24 hours in order to thoroughly dry the material. Additives such as salts, imidazole, and morphology control agents such as phenolics, polyimides were added to the solution before casting the membranes. Optionally, it is possible to add salt and morphology control agents such as polyimides and phenolics during the sulfonation procedure.

Membrane Processing: The dry pellets are taken from the convection oven and solvent-blended with dimethylacetamide (DMAc) or N-methylpyrrolidone (NMP), appropriate salts (e.g. Cs₂SO₄), HPA's (e.g. phosphotungstic acid), and/or imidazoles. These solutions can then be used to process membranes on glass panels with a draw-down machine. The solvent-laden membranes are placed in a vacuum oven at 50-80° C. and 26″ Hg for 1-4 hours to pull off the majority of the solvent. These membranes are then post-dried in an oven overnight at 50-80° C. The final films are homogeneous materials with a controlled thickness typically ranging from 1 to 20 mils (0.025 to 0.51 mm) having excellent dry and wet strengths.

Characterization: The membranes were characterized for sulfonate group by a standard titration method. The equivalent weights (EWs), which are defined as the number of grams of polymer per mole of fixed SO₃ sites, is determined for each membrane by the following method:
1. Weigh membrane to nearest 0.0001 g.
2. Place membrane in a 150-ml beaker with approximately 50 ml of DI H₂O for 5 minutes. Measure pH of water. Leaving membrane in beaker, decant the water.
3. Add approximately 50 ml of 2 M nitric acid for 30 minutes. Next, decant the nitric acid and add 50 ml of fresh nitric acid for an additional 30 minutes. Decant the nitric acid, leaving the membrane in the beaker.
4. Add approximately 50 ml of fresh DI H₂O to the beaker and allow the membrane to soak for 30 minutes. Decant the water and add approximately 50 ml of fresh DI H₂O to the beaker. Decant the water, leaving the membrane in the beaker.
5. Measure out 50 ml of 2 M NaCl in a 50-ml graduated cylinder and add to the beaker. Place the beaker on a magnetic stirrer plate on the lowest setting so that the NaCl solution is gently stirred. It may be necessary to hold the membrane against the bottom of the beaker with a stirring rod. Allow the membrane to soak in the NaCl for 60 minutes.
6. Using a 50-ml burette, titrate the NaCl solution with 0.01 M NaOH to its endpoint (pH=7).
7. Based on the volume of NaOH added to reach the endpoint, an EW can then be determined.
   Present titration data has shown improvements in synthesis procedures by an order of magnitude with an approximate EW range of 1500 to 2200 g per mol SO₃H. Titration data has shown the potential to reduce EW due to additions of Cs₂SO₄ salts.

Depending on level of sulfonation, equivalent weights in the range of one sulfonate group for 1500-3000 daltons the polymer were obtained. Sulfonate equivalents in the range of 600-1300 can be achieved with further optimization of the polymer structure and morphology.

Data on the moisture absorption of membranes were also measured as a function of humidity. We expect absorption data to be in the 30-40% range at low humidity.

Water Uptake: Water uptake studies can be performed to determine the absorption of water into the PEMs. Our initial test matrix uses one set temperature (40° C.) to control four humidity ranges (96%, 74%, 42% and 11%). The dry weight of four PEM replicates is recorded prior to testing. These PEMs are then placed into separate desiccator units each of which contains the necessary chemicals to produce the desired humidity levels as outlined in the following table:

| Chemicals | Temperature ° C. | % Humidity |
|---|---|---|
| Potassium Sulfate | 40 | 96 |
| Sodium Chloride | 40 | 74.7 |
| Potassium Carbonate | 40 | 42 |
| Lithium Chloride | 40 | 11 |

After a 24 hour exposure the weights of each PEM are quickly measured to determine the water uptake as a weight percent of water absorption.

Ionic Conductivity: One of the most critical parameters relating to the performance of polymer electrolyte membranes is ionic conductivity. This quantity is an expression of the inherent resistance of the membrane media to the transport of ions such as protons (H⁺). Electrochemical Impedance Spectroscopy (EIS) is a characterization technique often used to determine ionic conductivity, typically expressed in units of Siemens/cm. EIS entails the application of a modulated electrical potential through the volume of the material to be analyzed. As an experiment is carried out, the frequency of the modulated signal is systematically varied with time. The electrical potential of the applied field is constant over the course of the experiment and often ranges from 0.01 to 0.1 millivolts. The modulated electrical potential frequency range, sufficient for PEM membrane characterization, is typically between 0.1 to 60 kiloHertz. A more broad frequency range of applied electrical field may also be used ranging from 0.1 to 13 megaHertz. EIS characterization produces data, using a frequency response analyzer, on the change in electrical phase angle with applied frequency. As a result, the capacitance as well as real and imaginary impedance values may be determined. Extrapolation of an imaginary versus real impedance plot at high frequencies yields the material impedance at the real axis intercept. This value, in conjunction with the sample thickness and surface area, is used to compute the conductance. This technique has been utilized in previous studies such as J. A. Kolde et al., Proceedings of the First International Symposium on Proton Conducting Membrane Fuel Cells, The Electrochemical Society Proceedings, 95-23, 193, (1995) and by M. M. Nasef et al., J. App. Poly. Sci., 76, 11, (2000).

Evaluations of membranes in a fuel cell were conducted using a custom-made fuel cell using Nafion 117 as a control membrane material. The geometry of the cell was of traditional PEM design with a proton exchange membrane, treated at both surfaces with a 0.3 mg Pt catalyst and a porous carbon electrode. This system, known as the membrane electrode assembly (MEA) was located between a hydrogen gas source on one side and an oxygen gas source on the opposite side. The custom-made cell was implanted with heater inserts for maintaining constant temperature. Hydration of the respective gases, if desired, was achieved via bubbling fuel gases through water in an enclosed vessel. Typical experiments entailed fuel cell operation at a range of temperatures typically from 23 to 120° C. Experimental data consisted of fuel cell potential between the anode and cathode and current at a fixed electrical load value. The power output and current density was calculated from data collected over an extended period of time.

Based on the expected sulfonate equivalency in the range of 600-1000 and conductivity in the range of 0.1 or higher with further optimized films, we estimate membrane performance to show a voltage of 600-700 mV at a current density of 500-600 mA/cm².

Fuel Cell System

The present invention relates to a fuel cell system having a method of removing contaminants from the fuel cell electrode as described above, or having an improved polymer electrolyte membrane as described above. Either the methods or the membranes alone provide advantages in a fuel cell system. The methods in particular provide advantages when used in combination with a high temperature membrane (capable of operating satisfactorily at temperatures above 100° C.). For example, the combination of the method and a high temperature membrane allows a preferred method of allowing fuel cell operation with high levels of contaminants such as carbon monoxide. Since the membrane can operate at temperatures above 100° C., where CO contamination is reduced, and since the method oxidizes CO, both the membrane and the method together will improve CO tolerance in the fuel cell. At higher operating temperatures, permitted by the high temperature membranes, the cleaning voltage will be lower to oxidize the CO. Similarly, the method will not need to spend as much time in the cleaning mode when the membrane is used. A fuel cell system including both the method and the membrane allows operation at lower temperature for CO controls and less time at the cleaning voltage. Therefore, substantial advantages are obtained when both are used together in a fuel cell system.

Any type of high temperature membrane can be used with one of the methods of the invention. Such membranes are under active development (FY 2002 Progress Report for Hydrogen, Fuel Cells, and Infrastructure Technologies Program, Department of Energy). For example, 3M Fuel Cell Components Program is currently marketing a high temperature membrane as part of an improved membrane electrode assembly, also discussed in the Hydrogen, Fuel Cells and Infrastructure Technologies FY2002 Progress Report, pages 379-385. In some preferred embodiments, one of the methods of the invention is used in combination with one of the membranes of the invention to provide significant operating advantages for the fuel cell system.

Of course, methods of the invention provide advantages when used with any type of membrane. For example, the optimal operating temperature of a membrane for CO tolerance will be reduced when the method is used. The membranes of the invention also provide advantages when used alone. For example, the use of one of membranes allows for reduced water management balance of plant components and less restrictive performance requirements for the fuel processor.

The optimum operating temperature can be determined by the membrane characteristics and the method characteristics, as well as the CO level in the fuel stream.

The fuel cell system includes a fuel processor for producing hydrogen from a fuel, usually a hydrocarbon fuel. In a preferred embodiment, the fuel processor extracts hydrogen from methanol. Preferably, the fuel processor is based on Battelle's micro-chemical and micro-thermal system (“microcats”) technology (a.k.a. “microtech”), such as described in U.S. Pat. No. 6,192,596 to Bennett et al., issued Feb. 27, 2001 (incorporated by reference herein). This fuel processor includes an active microchannel fluid processing unit. Advantageously, the use of this preferred fuel processor technology allows for reduced fuel processor size and weight due to the process intensification of the technology.

The fuel cell system also includes a fuel cell stack consisting of multiple layers including gas diffusion layers, catalyst layers and polymer electrolyte membranes, in which electrons are separated from hydrogen to form protons on one side of the membrane, after which the protons pass through the polymer membrane to form water in the presence of oxygen on the opposite side of the membrane.

The principle and mode of operation of this invention have been described in its preferred embodiments. However, it should be noted that this invention may be practiced otherwise than as specifically illustrated and described without departing from its scope.

1. A fuel cell system comprising:
a stack of fuel cells including a plurality of interleaved layers of polymer electrolyte membranes, electrodes, and catalysts;
apparatus to provide a fuel to the fuel cells; and
a method of optimizing a waveform of an electrical current applied to the electrodes, comprising the steps of:
applying an electrical current to the electrodes;
determining a waveform of the voltage or the current of the electrical current;
representing the waveform by a mathematical description;
measuring a function of the fuel cells associated with the application of the electrical current;
feeding the waveform description and the measurements to an algorithm, including an optimization routine which uses the description to optimize the function of the fuel cells; and
performing calculations to determine values of the waveform description which optimize the function of the fuel cells, and thereby determine an optimized waveform of the electrical current to be applied to the electrodes of the fuel cells.

2. A fuel cell system according to claim 1 wherein the apparatus to provide fuel is a simplified fuel processor including a fuel reformer and excluding at least one of a water-gas shift reactor and a CO cleanup reactor.

3. A fuel cell system according to claim 1 wherein the polymer electrolyte membranes can operate at temperatures above 100° C.

4. A fuel cell system according to claim 1 wherein the polymer electrolyte membranes comprise proton conducting hydrocarbon-based polymer membranes, the polymer having a backbone and having acidic groups on side chains attached to the backbone.

5. A fuel cell system according to claim 1 wherein the polymer electrolyte membranes comprise proton conducting hydrocarbon-based polymer membranes, the membranes comprising a basic material in combination with an acidic material selected from acidic hydrocarbon-based polymers, acidic hydrocarbon-based oligomers, and blends thereof.

6. A fuel cell system comprising:
a stack of fuel cells including a plurality of interleaved layers of polymer electrolyte membranes, anodes, cathodes, and catalysts;
apparatus to provide a fuel to the fuel cells; and
a method of removing contaminants from the anodes of the fuel cells, comprising:
applying an electrical current to the anodes; and
pulsing the voltage of the electrical current during the application, such that an overvoltage at the anodes is negative during the pulses, and the overvoltage at the anodes is positive between the pulses.

7. A fuel cell system according to claim 6 wherein the polymer electrolyte membranes can operate at temperatures above 100° C.

8. A fuel cell system according to claim 6 wherein the polymer electrolyte membranes comprise proton conducting hydrocarbon-based polymer membranes, the polymer having a backbone and having acidic groups on side chains attached to the backbone.

9. A fuel cell system according to claim 6 wherein the polymer electrolyte membranes comprise proton conducting hydrocarbon-based polymer membranes, the membranes comprising a basic material in combination with an acidic material selected from acidic hydrocarbon-based polymers, acidic hydrocarbon-based oligomers, and blends thereof.

10. A fuel cell system comprising:
a stack of fuel cells including a plurality of interleaved layers of polymer electrolyte membranes, electrodes, and catalysts;
apparatus to provide a fuel to the fuel cells, the fuel containing at least one percent of an electrochemically active contaminant; and
a method of operating the fuel cells comprising applying an overvoltage to the electrodes of the fuel cells, and varying the overvoltage between a low value normally used for power production and a high value for cleaning the contaminant from the electrodes.

11. A fuel cell system according to claim 10 wherein the electrodes include anodes and cathodes, and wherein the overvoltage is applied to the anodes.

12. A fuel cell system according to claim 10 wherein the contaminant is CO.

13. A fuel cell system according to claim 10 wherein the polymer electrolyte membranes can operate at temperatures above 100° C.

14. A fuel cell system according to claim 10 wherein the polymer electrolyte membranes comprise proton conducting hydrocarbon-based polymer membranes, the polymer having a backbone and having acidic groups on side chains attached to the backbone.

15. A fuel cell system according to claim 10 wherein the polymer electrolyte membranes comprise proton conducting hydrocarbon-based polymer membranes, the membranes comprising a basic material in combination with an acidic material selected from acidic hydrocarbon-based polymers, acidic hydrocarbon-based oligomers, and blends thereof.

16. A fuel cell system comprising:
a stack of fuel cells including a plurality of interleaved layers of polymer electrolyte membranes, anodes, cathodes, and catalysts;
apparatus to provide a fuel to the fuel cells, the fuel containing an electrochemically active contaminant; and
a feedback control method of operating the fuel cells comprising applying voltage control to the anodes using the following algorithm:
(a) determining a mathematical model that relates an instantaneous coverage of the fuel and an instantaneous coverage of the contaminant on the anodes to an overvoltage applied to the anodes;
(b) forming an observer that relates the instantaneous coverage of the fuel and the contaminant to a measured current of the fuel cells;
(c) driving an estimated contaminant coverage to a low value by varying the overvoltage;
(d) driving an estimated fuel coverage to a high value by varying the overvoltage; and
(e) repeating steps (a) through (d) as necessary.

17. A fuel cell system according to claim 16 wherein the contaminant is carbon monoxide at a level of greater than one percent in the hydrogen.

18. A fuel cell system according to claim 16 wherein the algorithm comprises the additional steps, between steps (b) and (c), of (b1) prescribing a desired trajectory of the instantaneous coverage of the fuel and the contaminant as a function of time, and (b2) forming a set of mathematical relationships from steps (a), (b) and (b1) that allows the current to be measured, the overvoltage to be prescribed, and the instantaneous contaminant coverage and the instantaneous fuel coverage to be estimated.

19. A fuel cell system according to claim 16 wherein the polymer electrolyte membranes can operate at temperatures above 100° C.

20. A fuel cell system according to claim 16 wherein the polymer electrolyte membranes comprise proton conducting hydrocarbon-based polymer membranes, the polymer having a backbone and having acidic groups on side chains attached to the backbone.

21. A fuel cell system according to claim 16 wherein the polymer electrolyte membranes comprise proton conducting hydrocarbon-based polymer membranes, the membranes comprising a basic material in combination with an acidic material selected from acidic hydrocarbon-based polymers, acidic hydrocarbon-based oligomers, and blends thereof.

22. A fuel cell system comprising:
a stack of fuel cells including a plurality of interleaved layers of polymer electrolyte membranes, electrodes, and catalysts; and
apparatus to provide a fuel to the fuel cells;
where the polymer electrolyte membranes comprise proton conducting hydrocarbon-based polymer membranes, the polymer having a backbone and having acidic groups on side chains attached to the backbone.

23. A fuel cell system according to claim 22 wherein the polymer electrolyte membranes can operate at temperatures above 100° C.

24. A fuel cell system according to claim 22 wherein the fuel is methanol.

25. A fuel cell system comprising:
a stack of fuel cells including a plurality of interleaved layers of polymer electrolyte membranes, electrodes, and catalysts; and
apparatus to provide a fuel to the fuel cells;
where the polymer electrolyte membranes comprise proton conducting membranes, the membranes comprising a basic material in combination with an acidic material selected from acidic hydrocarbon-based polymers, acidic hydrocarbon-based oligomers, and blends thereof.

26. A fuel cell system according to claim 25 wherein the polymer electrolyte membranes can operate at temperatures above 100° C.

27. A fuel cell system according to claim 25 wherein the fuel is methanol.

28. A fuel cell system comprising:
a stack of fuel cells including a plurality of interleaved layers of polymer electrolyte membranes, electrodes, and catalysts; and
apparatus to provide a fuel to the fuel cells;
where the polymer electrolyte membranes comprise proton conducting hydrocarbon-based polymer membranes having a phase separated morphological microstructure.

29. A fuel cell system comprising:
a stack of fuel cells including a plurality of interleaved layers of polymer electrolyte membranes, electrodes, and catalysts; and
apparatus to provide a fuel to the fuel cells;
where the polymer electrolyte membranes comprise proton conducting membranes produced from a solid hydrocarbon-based polymer in combination with a gel hydrocarbon-based polymer, the solid and gel polymers having acidic groups.

30. A fuel cell system comprising:
a stack of fuel cells including a plurality of interleaved layers of polymer electrolyte membranes, electrodes, and catalysts; and
apparatus to provide a fuel to the fuel cells;
where the polymer electrolyte membranes comprise proton conducting membranes, the membranes comprising an epoxy-containing polymer in combination with a nitrogen-containing compound.
